(19) United States
(12) Patent Application Publication
(10) Pub. No.: US 2026/0197170 A1
(43) Pub. Date: Jul. 9, 2026

(54) ENHANCED RESOURCE SECURITY VIA DYNAMICALLY GENERATED TOKENS

(71) Applicant: Live Nation Entertainment, Inc., Beverly Hills, CA (US)

(72) Inventors: Pierre Lafon, Quebec City (CA); Jonathan Marchand, Quebec City (CA); Anas El Hajjaji, Quebec City (CA); Alanna Kitaeff, Los Angeles, CA (US); Philippe Lefebvre, Quebec City (CA); Gregory J. Bowyer, Seattle, WA (US); Jonathan Backer, Los Angeles, CA (US)

(73) Assignee: Live Nation Entertainment, Inc., Beverly Hills, CA (US)

(21) Appl. No.: 19/445,330

(22) Filed: Jan. 9, 2026

Related U.S. Application Data
(60) Provisional application No. 63/743,531, filed on Jan. 9, 2025.

(51) Int. Cl. H04L 9/32; H04L 9/00

(52) U.S. Cl. CPC H04L 9/3213; H04L 9/006; H04L 9/3247; H04L 9/3263

(57) ABSTRACT

A system and method for securely managing event resources includes receiving a request for a resource from a user device via an API gateway; generating and displaying a list of available resources; and receiving a request for a selected resource. The method involves verifying an attestation of a cryptographic key pair generated by a secure element on the user device, by validating a certificate of conformance. The secure element further creates a digital signature by using a private key. A server issues a token by embedding a public key and the digital signature in the token. The server transmits a notification to the user device confirming an issuance of the token and updates a database with transaction details. At an event location, the server retrieves the public key from the token to verify against the public key stored in the database. Upon successful validation, access is granted.

This application is a non-provisional of and claims priority to U.S. Provisional Application No. 63/743,531, filed on January 9, 2025, which is incorporated herein by reference for all purposes.

### PRIORITY

### BACKGROUND

In recent years, there has been a significant demand for more secure and effective methods to prevent unauthorized duplication and enable a secure transfer of allocated resources. This concern is particularly pronounced due to the increasing manipulation of rotating tokens, which are often exploited in resource counterfeiting. Moreover, when the allocated resources are transferred between different users or devices, security risks escalate. Unauthorized brokers frequently take advantage of open systems by creating fake applications that mimic official services, thereby bypassing existing security measures.

Additionally, event locations often encounter connectivity issues, which complicate the real-time verification of the allocated resources. This challenge underscores the need for solutions that can verify the allocated resources offline without compromising security. The presence of the unauthorized brokers further exacerbates the problem, as they integrate into resource management systems without secure protocols, leading to increased fraud. Therefore, there is a growing need for an efficient and secure method to address these vulnerabilities and enhance the overall resource allocation process.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

A system and method for securely managing event resources. A request is received for a resource from a user device via an API gateway. A list of available resources is generated and displayed. A request for a selected resource is received. The method involves verifying an attestation of a cryptographic key pair generated by a secure element on the user device, by validating a certificate of conformance. The secure element further creates a digital signature by using a private key. A server issues a token by embedding a public key and the digital signature in the token. The server transmits a notification to the user device confirming an issuance of the token and updates a database with transaction details. At an event location, the server retrieves the public key from the token to verify against the public key stored in the database. Upon successful validation, access is granted.

Implementations may include one or more of the following features. The method that involves generating a list of available resources of an event based on receiving a request for a resource associated with the event from a user device further includes dynamically generating the list based on real-time availability data. The user device is connected to a server via an application programming interface (API) gateway. A cryptographic key pair including a private key and a public key, is generated, on receiving a request for a selected resource, by a secure element that is a hardware-protected module in the user device. The cryptographic key pair enables the private key to remain resistant to tampering and confidential within the secure element, and the secure element creates a digital signature by signing the public key using a certificate of conformance to attest to trustworthiness of the cryptographic key pair. The digital signature is created by the private key and includes metadata identifying an origin of the secure element, and the secure element further refreshes the digital signature at predefined intervals. The method involves using the server that verifies an attestation of the cryptographic key pair by validating the certificate of conformance when the certificate of conformance is listed in a pre-approved certificate authority repository. The server issues a token generated by embedding the public key and the digital signature into the token. The token is periodically refreshed by updating the digital signature, preventing token duplication or unauthorized reuse. The server involves transmitting a notification confirming an issuance of token to the user device, that includes a digitally signed confirmation, functioning as a proof of the issuance of token and secure binding to the user device. A database is configured to store an immutable record of transactions, ensuring that the issuance of token and associated data are unaltered post-issuance. The database is updated by storing an issuance record for the token. The method further involves validating the token at a scanning terminal of an event location, and the scanning terminal retrieves and verifies the public key embedded within the token against the public key stored in the database. The scanning terminal further performs an offline validation of the token by retrieving and verifying the public key and the digital signature embedded in the token against locally stored verification data. The scanning terminal is further configured to generate a real-time access log, recording a success or failure of token validation attempts, and transmitting the real-time access log to the server for audit and security purposes. The method involves using the server for issuing a new token upon receiving a resource transfer request, where the new token is generated with a new cryptographic key pair, securely binding the new token to a different user device. The server includes an access management module that dynamically adjusts access rights based on real-time event conditions, including changes in resource availability, user authentication, and/or security alerts. The method further involves using the server for generating a temporary token and sending the temporary token to a wallet of the user device, when the certificate of conformance is invalid. The server further assesses a usage of an attested cryptographic key pair to detect an irrational pattern exhibited by the user device, and invalidates the attested cryptographic key pair and/or restricts the user device from getting the token upon detection of the irrational pattern. While the scanning terminal grants access to the event based on a successful validation of the token. Implementations of the described techniques may include hardware, a method or process, or computer software on a computer-accessible medium.

In an embodiment, a system for securely managing event resources is disclosed. The system includes a user device configured to request a resource associated with an event, and is connected to a server via an API gateway. The server receives a request for the resource and generates a list of available resources, generated dynamically based on real-time availability data. The server receives a request for a selected resource. A cryptographic key pair including a private key and a public key, is generated by a secure element that is a hardware-protected module in the user device. The cryptographic key pair enables the private key to remain resistant to tampering and confidential within the secure element, and the secure element creates a digital signature by signing the public key using a certificate of conformance to attest to trustworthiness of the cryptographic key pair. The digital signature is created by the private key and includes metadata identifying an origin of the secure element, and the secure element further refreshes the digital signature at predefined intervals. The server verifies an attestation of the cryptographic key pair by validating the certificate of conformance when the certificate of conformance is listed in a pre-approved certificate authority repository. The server issues a token generated by embedding the public key and the digital signature into the token. The server involves transmitting a notification confirming an issuance of token to the user device, that includes a digitally signed confirmation, functioning as a proof of the issuance of token and secure binding to the user device. A database is updated with transaction details by storing an issuance record for the token. The token is validated at a scanning terminal of an event location, and the scanning terminal retrieves and verifies the public key embedded within the token against the public key stored in the database. The scanning terminal further performs an offline validation of the token by retrieving and verifying the public key and the digital signature embedded in the token against locally stored verification data. The server for issues a new token upon receiving a resource transfer request, where the new token is generated with a new cryptographic key pair, securely binding the new token to a different user device. The server includes an access management module that dynamically adjusts access rights based on real-time event conditions, including changes in resource availability, user authentication, and/or security alerts. The system further involves using the server for generating a temporary token and sending the temporary token to a wallet of the user device, when the certificate of conformance is invalid. The server further assesses a usage of an attested cryptographic key pair to detect an irrational pattern exhibited by the user device, and invalidates the attested cryptographic key pair and/or restricts the user device from getting the token upon detection of the irrational pattern. While the scanning terminal grants access to the event based on a successful validation of the token. Other embodiments of this aspect include corresponding computer systems, apparatus, and computer programs recorded on one or more computer storage devices, each configured to perform the actions of the methods.

### BRIEF DESCRIPTION OF THE DRAWINGS

The present disclosure is described in conjunction with the appended figures:

FIG. 1 illustrates an architecture of a resource allocating service in accordance with an embodiment of the present disclosure.

FIG. 2 illustrates a system using a resource management system and an access management system for secure resource allocation and validation in accordance with an embodiment of the present disclosure.

FIG. 3 illustrates a private key and token binding on a user device, focusing on transfer and re-allocation of an event resource in accordance with an embodiment of the present disclosure.

FIG. 4 illustrates a device authentication system configured to assess security of the user device in accordance with an embodiment of the present disclosure.

FIG. 5 illustrates an embodiment of the access management system in accordance with an embodiment of the present disclosure.

FIG. 6 illustrates an example embodiment of a token verification method.

FIG. 7 illustrates an example embodiment of an authentication method for generating a private key, creating a dynamic token, and verifying access at an event location.

FIG. 8 illustrates an example embodiment of a resource transfer between devices, including key-pair generation, resource invalidation, and server updates.

FIG. 9 illustrates an example embodiment of a token verification process, validating the public key and digital signature before granting access.

FIG. 10 illustrates a process of binding in the resource transfer, including API security enforcement and binding the new ticket to a new device in accordance with an embodiment of the present disclosure.

FIG. 11 represents an internal storage architecture of the user device in accordance with an embodiment of the present disclosure.

FIG. 12 illustrates a network setup for resource issuance and verification, highlighting the roles of resource issuer, security terminal, and access management system in accordance with an embodiment of the present disclosure.

FIG. 13 illustrates a method for generating and validating the event resources in accordance with an embodiment of the present disclosure.

FIG. 14 illustrates a block diagram of the user device in accordance with an embodiment of the present disclosure.

In the appended figures, similar components and/or features may have the same reference label. Further, various components of the same type may be distinguished by following the reference label with a second alphabetical label that distinguishes among the similar components. If the first reference label is used in the specification, the description applies to any one of the similar components having the same first reference label irrespective of the second reference label.

### DETAILED DESCRIPTION

The ensuing description provides preferred exemplary embodiment(s) and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

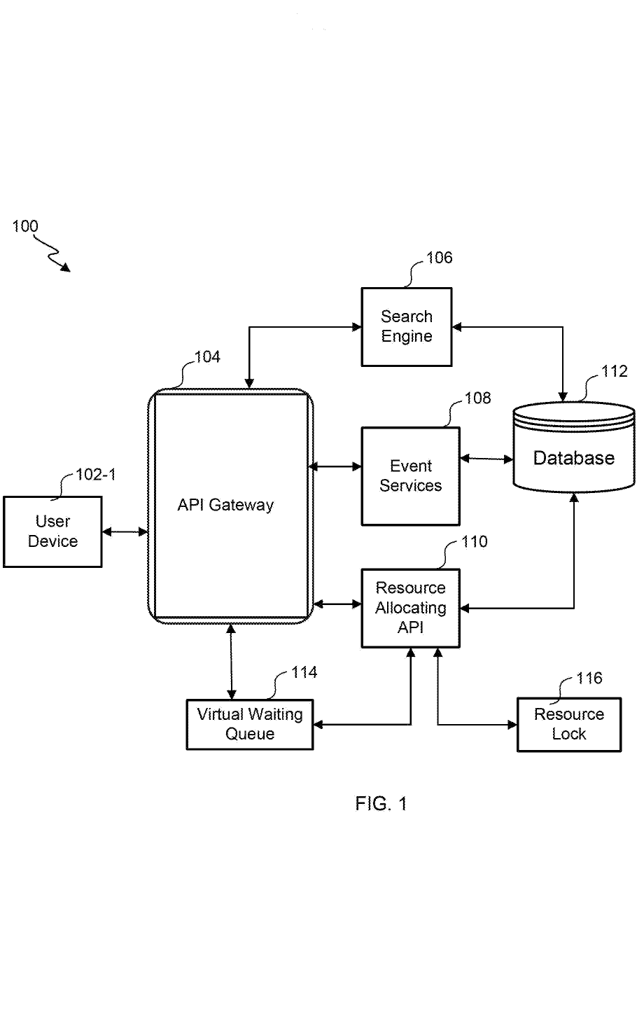

Referring to FIG. 1, an architecture 100 of a resource allocating service, designed to securely provide resources of an event, is illustrated. Examples of the event include, but are not limited to, a match, a concert, and a movie screening. The architecture 100 includes several components that work together to provide a seamless user experience and ensures reliability, scalability, and data integrity. The architecture 100 includes a user device 102-1, an application programming interface (API) gateway 104, a search engine 106, event services 108, a resource allocating API 110, a database 112, a virtual waiting queue 114, and a resource lock 116. The resource allocating service is an application that allocates event resources to users, enabling a user to access the event by using a resource. In some embodiments, the resource represents a ticket the user attains to access the event. From herein, the term “resources” and “event resources” are used interchangeably.

In some embodiments, the architecture 100 begins with the user device 102-1, such as a smartphone, tablet, or computer. The user device 102-1 enables the user to interact with the resource allocating service. The user sends requests to the resource allocating service through the user device 102-1. In one embodiment, the user queries the resource allocating service to obtain information about upcoming events, such as an event location, a seat map of the event location, available resources, and a resource rate. Examples of the event location include, but are not limited to a theater, a stadium, a club, and an arena. The user selects a resource and sends a reservation request to the resource allocating service via the user device 102-1. The user device 102-1 is configured to request the resource. When the resource is allocated, the user device 102-1 saves the resource and the user presents the resource saved in the user device 102-1 at the event location to access the event.

The user device 102-1 communicates with the resource allocating service via the API gateway 104. The API gateway 104 serves as a central entry point for the requests. The API gateway 104 performs functions, including user authentication, rate limiting to prevent the resource allocating service from overloading, and routing incoming API requests to appropriate backend services, such as the search engine 106, event services 108, and resource allocating API 110. In some embodiments, the API gateway 104 further performs request validation and security enforcement to ensure that only compliant and authenticated requests reach the backend services.

In this regard, the search engine 106 is a dedicated service that provides the users with the ability to search for events based on various criteria, such as an event name, the event location, an event type, and an event date. The search engine 106 interacts with the database 112 to retrieve event-related data. For optimized performance, particularly under high-demand scenarios, the search engine 106 may utilize a search-optimized database that employs techniques, such as inverted indexing and geospatial queries to quickly retrieve search results.

Further, the event services 108 are responsible for managing the event-related data, including event details, the event location, performer details, and the available resources. The event services 108 interact with the database 112 to store and retrieve the event-related data, enabling the users to view comprehensive event details, including the seat map and the available resources.

Furthermore, the resource allocating API 110 handles resource allocation process. The resource allocating API 110 manages a two-phase process that includes resource reservation and resource allocation. In a first phase, when the user selects the resource, the resource allocating API 110 temporarily reserves the resource by interacting with the database 112 and updates a status of the resource to "reserved." This reservation is typically held for a limited time, such as 10 minutes, to allow the user to render the resource rate to complete a transaction. In some embodiments, the resource rate represents a value of the ticket the user pays. In a second phase, once the user renders the resource rate and the transaction is successful, the resource allocating API 110 updates the status to "allocated," indicating that the resource is unavailable for other users.

In some embodiments, the database 112 serves as a central repository for data related to events, the event resources, event locations, and performers. The database 112 includes multiple tables that store specific information. For example, an event table stores an event identifier (id), an event location id, a performer id, the event name, event description, and the available resources. A location table includes the event location id, event location, seat map, and capacity to accommodate users at the event location. A performer table holds details about performers, including the performer id, performer names, and associated event id; and a resource table stores resource-specific data, such as a resource id, a seat location at the seat map, the resource rate, and the status. The status of the resource can be available, reserved, or allocated. The database 112 enables data consistency and integrity, particularly during the resource allocation process, where the database 112 prevents issues such as double allocation by enforcing atomicity in transactions.

In some embodiments, to handle high-demand scenarios, the resource allocating API 110 is equipped with advanced features such as the virtual waiting queue 114 and the resource lock 116. In an embodiment, the virtual waiting queue 114 is designed to manage scenarios where demand for the resources exceeds the available resources, such as for high-demand events. In such cases, the requests of the users are placed in the virtual waiting queue 114 in place of immediately processing the requests, which prevents the resource allocating service from overloading and enables a fair distribution of the resources among the users. The virtual waiting queue 114 is implemented by using a queue data structure, such as a first-in-first-out queue that orders users based on the time they entered the queue.

In one exemplary embodiment, the resource lock 116 is another advanced feature implemented using a distributed cache system. When the resource is reserved, the resource lock 116 temporarily locks the resource in the cache with a time-to-live (TTL), such as 10 minutes, preventing other users from reserving the same resource during a reservation period. If the reservation period expires, indicating that the user failed to render the resource rate within the reservation period, the resource lock 116 releases the resource, making the resource available for other users.

In one exemplary embodiment, the architecture 100 is designed to provide a comprehensive and scalable solution for managing the resources of the events. The API gateway 104 efficiently routes the requests to the appropriate services, ensuring that the users can search for the events, view event details, and attain the resources securely. The search engine 106 and event services 108 work closely with the database 112 to provide the users with accurate and up-to-date information. Meanwhile, the resource allocation API 110, supported by the virtual waiting queue 114 and resource lock 116, enables that the resources are reserved and allocated in a manner that prevents double allocation and effectively manages the high-demand scenarios.

In one exemplary embodiment, the resource allocating service incorporates advanced search capabilities and uses the search engine 106 with elastic-search integration. This allows the users to perform more complex searches, including geospatial queries with low latency. Additionally, the resource allocating service employs server-sent events (SSE) or web sockets to provide real-time updates to the user device 102-1, ensuring that the resource availability is accurately reflected even as other users reserve or attain the resources. The resource allocating service enables the user to reserve multiple resources of the event.

In one exemplary embodiment, the resource allocating service is optimized to handle high-demand scenarios using the virtual waiting queue 114. For the high-demand events, expected to attract large crowds, the reservation requests are placed in the virtual waiting queue 114, preventing the resource allocating service from overloading and ensuring a fair distribution of the resources. In yet another embodiment, the resource allocating service uses the resource lock 116 to prevent multiple users from reserving or attaining the same resource simultaneously.

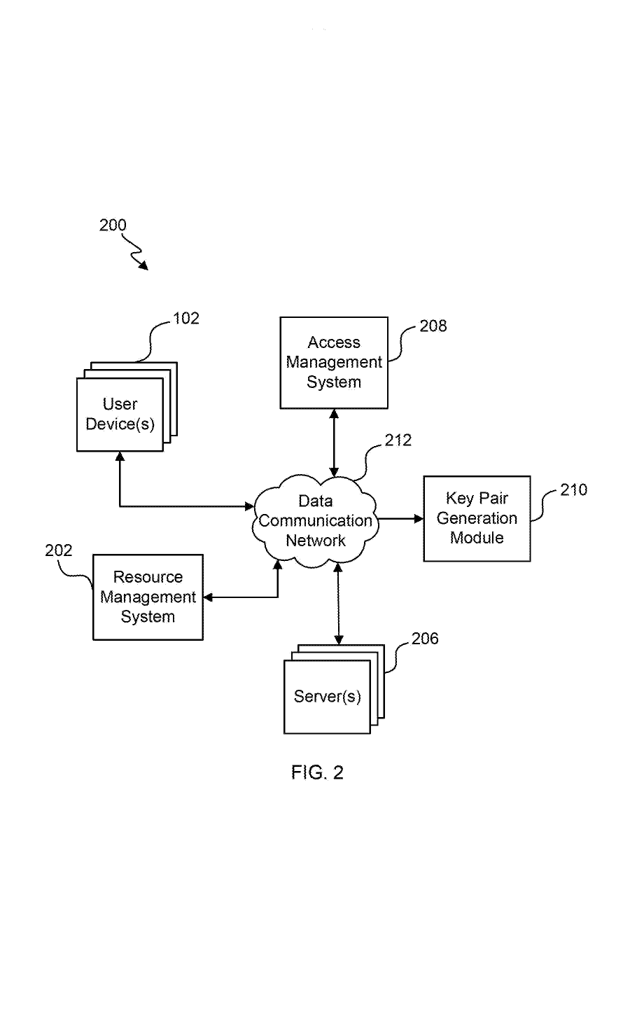

Referring next to FIG. 2, a system 200 includes several interconnected components, namely a resource management system 202, user device(s) 102, server(s) 206, an access management system 208, and a key pair generation module 210, an individual of which communicates with one another via a data communication network 212. The data communication network 212 includes the API gateway 104 that connects the components of the system 200. From herein, the terms “user device” and “user device(s)” are used interchangeably throughout this disclosure. Also, the terms “server” and “server(s)” are used interchangeably throughout this disclosure.

The resource management system 202, hosted by the server 206, serves as a central hub for managing the lifecycle of the event resources, from their creation and distribution to their verification and usage. The resource management system 202 interacts with various components to enable that the resources are securely allocated and managed throughout their lifecycle. The user devices 102 serve as primary interfaces through which the users interact with the resource management system 202 via the resource allocating service. The user devices 102 receive and store allocated resources, and the users present the allocated resources at the event location to access the event.

In an embodiment, the server 206 receives the request for the resource from the user device 102 via the API gateway 104, and forwards the request to the resource management system 202. The server 206, via the resource management system 202, dynamically generates a list of the available resources based on real-time availability data. The list is displayed on the user device 102 by the resource allocating service, and the user selects the resource from the list of the available resources. In another embodiment, the seat map generated on the resource allocating service displays the available resources and allocated resources. The server 206 receives the request for the selected resource from the user device 102. A cryptographic key pair is generated by a secure element on the user device 102. The secure element is a hardware-protected module located inside the user device 102. The server 206 verifies an attestation of the cryptographic key pair to determine whether the cryptographic key pair originates from a secure and authorized user device, and allocates the selected resource to the user if the user device 102 is secure.

In one exemplary embodiment, the key pair generation module 210 is operable within the secure element, housed inside the user device 102. The key pair generation module 210 generates the cryptographic key pair to be used in assessing security of the user device 102. Examples of the secure element include, but are not limited to, a chip, a smart card, and a subscriber identity module. The secure element is configured to generate the cryptographic key pair, including a public key and a private key, both of which are essential for the security of the resource allocation process. In this regard, the public key undergoes attestation (e.g., using a certificate of conformance) and is transmitted to a binding engine (not shown), while the private key is stored at a secure location within the secure element. The binding engine facilitates and maintains a secure association between the cryptographic key pair and the user device 102, effectively binding an identity of the user device 102 to the cryptographic key pair.

In an embodiment, the resource management system 202 reserves and allocates the selected resource and issues a token for the allocated resource when the user device 102 is secure. The token is distinctively tied to the cryptographic key pair, thereby ensuring that the token is specific for the user device 102. When the token is rendered or presented on the user device 102, the secure element computes a digital signature utilizing the private key, and the digital signature is embedded in the token. The secure element creates the digital signature by signing the public key using the certificate of conformance. In an embodiment, the digital signature includes metadata identifying an origin of the secure element. This configuration ensures that the token is distinctively associated with a specific user and the user device 102, thereby preventing unauthorized duplication or misuse of the token.

The server 206 also interacts with the access management system 208, which controls access to the event. The access management system 208 verifies the tokens of the allocated resources at the event location. The access management system 208 uses the public key associated with the token to validate the digital signature in the token generated by using the private key. The digital signature is verified at a scanning terminal to confirm the authenticity of the token. A validation of the digital signature further confirms that the token is bound to the user device 102 and has not been tampered with. Examples of the token include, but are not limited to, a barcode, an access code, and a quick response (QR) code.

In one exemplary embodiment, by tying the token to the cryptographic key pair, the system 200 ensures that only a legitimate user device having the allocated resource can generate the digital signature via the private key, and obtain the token for the allocated resource. When the token is validated at the event location, the access management system 208 allows a legitimate user to enter the event location to access the event. In one embodiment, the event location represents a venue where the event takes place. This mechanism significantly reduces the risk of resource fraud, such as an attempt to forge or duplicate the token devoid of the corresponding private key would result in a failed verification by the access management system 208.

In one exemplary embodiment, the present disclosure includes the resource management system 202, responsible for issuing and verifying the event resources by using the cryptographic key pair. When the user renders the resource rate, the key pair generation module 210, embedded within the secure element on the user device 102, generates the cryptographic key pair. The secure element generates both the public key and the private key, whereupon the public key is attested and transmitted to the binding engine. The binding engine securely associates the public key with the user device 102, binding the identity of the user device 102 to the cryptographic key pair.

Following a key binding of the user device 102 and the cryptographic key pair, the resource management system 202 issues the token that is distinctively associated with the key binding. During the resource allocation process, the secure element computes the digital signature using the private key. The private key remains strictly confidential within the secure element and is resistant to tampering. Upon presentation of the token at the event location, the access management system 208 verifies the authenticity of the token by validating the digital signature with the public key. This configuration confirms that the token is distinctively associated with the legitimate user and the user device 102, thereby preventing unauthorized duplication or misuse of the token.

In an embodiment, the server 206 transmits a notification on the user device 102 to confirm an issuance of the token and updates the database 112 with transaction details by storing an issuance record of the token. The notification includes a digitally signed confirmation, serving as a proof of the issuance of the token and secure binding to the user device 102. In another exemplary embodiment, the system 200 leverages the private key stored on the user device 102 to generate dynamically changing tokens. An individual token is encoded with the secure element by using the private key to create the digital signature using the private key. The token is set to rotate at predefined intervals, making it difficult for counterfeiters to duplicate. When the user presents the token at the event location, the access management system 208 verifies the token by analyzing an output generated from the digital signature, the public key, and a resource payload of the token against an expected output generated using locally stored verification data. The locally stored verification data includes the public key and the resource payload stored in the database 112 at the event location.

In one exemplary embodiment, the present disclosure includes the system 200 configured to facilitate offline token verification, which is beneficial in environments where internet connectivity is limited or unreliable. In this offline verification method, the resource management system 202 issues the token that is matchlessly associated with the key binding. In an embodiment, the resource payload includes the public key associated with the key binding and the metadata of the user device 102, which is important for the offline verification process. To prevent resource forgery, the resource management system 202 further signs the token with an event hash-based message authentication code (HMAC) key, which is a cryptographic key generated by the resource management system 202 and subsequently provided to the access management system 208 for use in secure verification.

During the offline verification, the access management system 208 initially validates the token by verifying the digital signature with the event HMAC key, thereby ensuring that the token has not been tampered with or forged. Upon confirming the token’s integrity, the access management system 208 extracts the key binding and the public key from the resource payload embedded in the token. This public key is then utilized to verify the digital signature embedded in the token, which is generated by the private key of the user device 102. This offline verification approach confirms that the token is authenticated securely and is matchlessly associated with a specific device, providing robust security and preventing unauthorized duplication or misuse of the token, even in offline scenarios.

In another exemplary embodiment, the present disclosure provides the system 200 for facilitating the secure transfer and reallocation of the event resources between the users. Upon initiation of a resource transfer, the token is invalidated, and a new token is issued. The new token is matchlessly associated with the key binding of the user device 102 of a new user. Furthermore, no transfer of the private key occurs between the users, as the private key remains strictly confined within the secure element of the user device 102 and is never exposed or transmitted externally.

Further, the new user renders the resource rate and attains the new token for the allocated resource. When the token is presented at the event location, the access management system 208 verifies its authenticity by validating the digital signature with the public key linked to the new key binding, thereby enabling a secure and authenticated resource transfer mechanism in compliance with robust security basics.

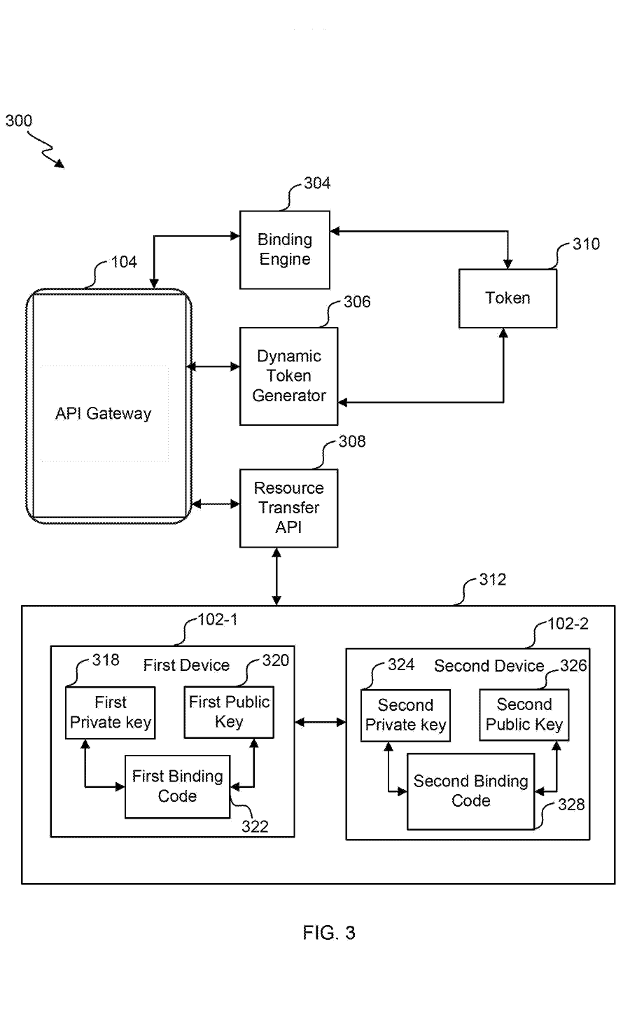

Referring next to FIG. 3, a private key and token binding 300 on the user device 102, focusing on resource reallocation and secure token generation, is illustrated. The private key and token binding 300 is illustrated by the API gateway 104, a binding engine 304, a dynamic token generator 306, a resource transfer API 308, a token 310, and a resource transfer module 312. The private key and token binding 300 confirms that the tokens are not only securely issued and stored, but also transferred between the users in a manner that prevents unauthorized access or duplication.

In one exemplary embodiment, the API gateway 104 serves as the central communication hub for routing the incoming and outgoing requests between the various components. The API gateway 104 is responsible for managing the interactions between the users and the components, ensuring that every transaction is handled securely and efficiently.

At the core of the token generation process is the binding engine 304, which is specifically designed to bind the cryptographic key pair including the private key to a dynamically generated token that changes at the predefined intervals. This binding confirms that the token 310 of the allocated resource is matchlessly tied to a specific user device, effectively preventing the unauthorized duplication or use of the token 310. The binding engine 304 works in conjunction with the dynamic token generator 306, which generates the tokens that change dynamically at the predetermined intervals. The digital signature embedded in the token 310 is periodically refreshed at the predefined intervals. This dynamic nature of the token 310 further enhances the security of the token 310, as the token 310 remains valid for a short duration, thereby reducing the risk of counterfeiting. The digital signature is updated to prevent the token 310 from duplication or unauthorized reuse. In one exemplary embodiment of the present disclosure, the dynamic token generator 306 is a component of the resource management system 202. The user accesses the token 310 on the resource allocating service, and displays the token 310 via the resource allocating service on the user device 102 at the event location.

The binding engine 304 associates the digital signature generated using the private key with the selected resource and embeds the digital signature within the token 310. In one exemplary embodiment, the binding engine 304 is also responsible for binding the identity of the user device 102 with the cryptographic key pair. Once the binding engine 304 and dynamic token generator 306 have completed their roles, the token 310 is allocated to the user device 102. The token 310 is generated against the allocated resource and is highly secure and resistant to tampering. The token 310 is then displayed by the resource allocating service on the user device 102 and is stored on the user device 102. The token 310 is then presented at the event location, where the token 310 is scanned and validated. The user is granted access to the event if the token 310 is valid.

In one embodiment, the token 310 serves as a paid ticket for the selected resource. In addition to token generation, the system 200 also incorporates a robust mechanism for the resource transfer and resource reallocation, managed by the resource transfer API 308. The resource transfer API 308 includes a specialized sub-module, the resource transfer module 312, which facilitates the secure transfer of the event resources from one user to another.

During the resource transfer, the resource transfer module 312 enables that the allocated resource is securely transferred from the user device 102-1 to the user device 102-2. The user device 102-1 includes a first private key 318, a first public key 320, and a first binding code 322 that associates the first private key 318 with the allocated resource. Similarly, the user device 102-2 includes a second private key 324, a second public key 326, and a second binding code 328 that links the second private key 324 with the allocated resource.

In some embodiments, upon initiation of the resource transfer by the user device 102-1, the resource transfer module 312 re-associates the allocated resource with the user device 102-2 devoid of triggering the generation of a new cryptographic key pair at this stage. In particular, the generation of the cryptographic key pair occurs while rendering the token 310 on the user device 102-2. In an embodiment, during a process of rendering the token 310, if the user device 102-2 already has the cryptographic key pair linked to an account on the resource allocating service, the cryptographic key pair is reused. The security of the user device 102-2 is analyzed, and the token 310 is generated if the user device 102-2 is secure. Otherwise, a new key binding is created to link the user device 102-2 to the resource allocating service.

Furthermore, the resource management system 202 invalidates the association of the token 310 with the first private key 318 to rebind the allocated resource to the second private key 324. The second public key 326 and second binding code 328 are stored, ensuring that the allocated resource is securely associated with the user device 102-2 and is no longer used or duplicated by the user of the user device 102-1. The API gateway 104 oversees secure communication between these components, ensuring that the resource transfer is conducted seamlessly and minus interruption.

In one exemplary embodiment, the resource management system 202 is configured to generate and issue a secure token using the binding engine 304 and dynamic token generator 306. When the user requests allocation of the selected resource by rendering the resource rate, the API gateway 104 routes the request to the binding engine 304, which embeds the digital signature computed by the private key into the dynamically generated token. The dynamic token generator 306 produces the token 310 that changes at the predefined intervals, ensuring that the token 310 remains secure against forgery. The token 310, which is tied to the private key and the resource payload, is then stored on the user device 102.

In one exemplary embodiment, the present disclosure focuses on the secure transfer of the allocated resource between the users, facilitated by the resource transfer API 308 and the resource transfer module 312. Upon initiation of the resource transfer by a first user, the resource management system 202 executes a secure process in which the allocated resource is reassociated with the key binding of a second user. Further, the resource management system 202 invalidates the key binding of the user device 102-1 while generating the token 310 for the user device 102-2. In this regard, a new token is generated and, in case the cryptographic key pair connected to the user device 102-2 is detected, it is reused. Otherwise, a new cryptographic key pair is generated to link the cryptographic key pair to the user device 102-2. The second binding code 328 on the user device 102-2 indicates that the allocated resource is securely transferred to the user device 102-2.

In one exemplary embodiment, the token 310 generated by the dynamic token generator 306 provides enhanced security. The token 310 is designed to expire after a short duration, making it difficult for counterfeiters to use the token 310 even if they manage to intercept it. The binding engine 304 enables that the token 310 is tied to the private key, and the dynamic token generator 306 continuously refreshes the token 310 at regular intervals.

In another exemplary embodiment, the system includes a fail-safe mechanism within the resource transfer API 308 to address potential interruptions during the resource transfer. If an issue occurs, such as a network failure or incomplete binding, the resource transfer API 308 can automatically revert the resource to its original state, ensuring that the resource is not lost or left in an invalid state. The API gateway 104 manages this fail-safe process by monitoring the transfer and initiating a rollback.

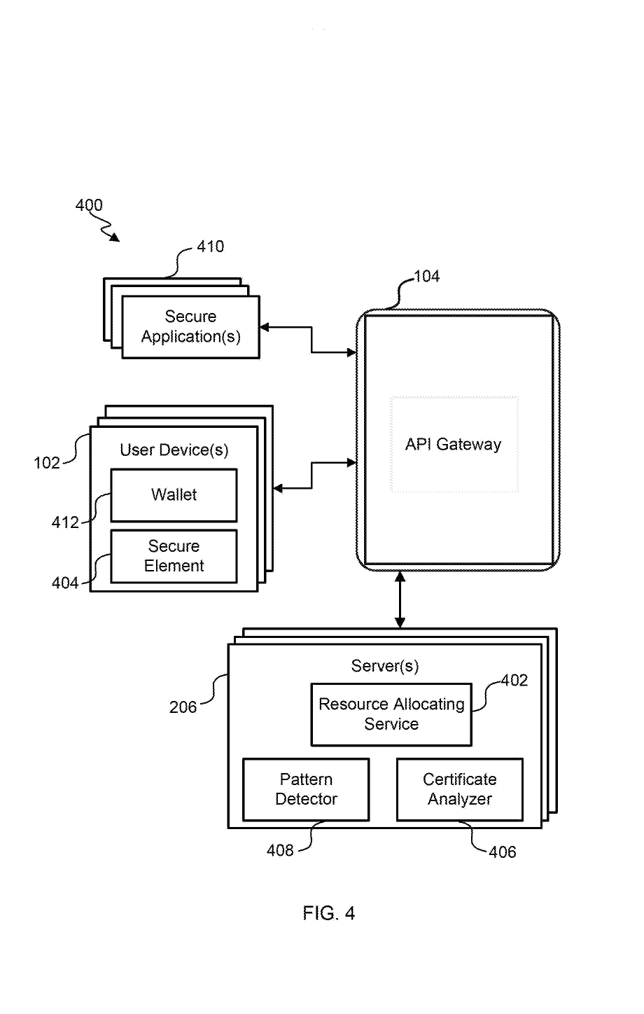

Referring next to FIG. 4, a device authentication system 400 configured to assess the security of the user device 102 is shown as an embodiment of the present disclosure. The device authentication system 400 includes the user device 102, the API gateway 104, the server 206, and secure application(s) 410. The device authentication system 400 works with a secure element 404 and a wallet 412 of the user device 102. The functionality of the server 206 in the device authentication system 400 is further depicted by a resource allocating service 402, a certificate analyzer 406, and a pattern detector 408.

The user device 102 requests the resource allocating service 402 for the allocation of the selected resource through the API gateway 104. The API gateway 104 forwards the request to the server 206. The server 206 communicates with the secure element 404 of the user device 102 to determine whether the identity of the user device 102 is bound to the cryptographic key pair. If the key binding exists, the server 206 assesses the security by using a pre-approved certificate authority repository. The server 206 receives the attestation of the cryptographic key pair and confirms whether the certificate of conformance is listed in the pre-approved certificate authority repository. However, if the key binding is not found, the server 206 requests the secure element 404 to generate the cryptographic key pair.

The secure element 404 generates the cryptographic key pair and stores the private key at the secure location within the secure element 404, to keep the private key confidential and resistant to tampering. The server 206 then requests the secure element 404 to attest the cryptographic key pair. The secure element 404 uses the certificate of conformance to digitally sign the public key with the private key, creating the digital signature. The secure element 404 creates the digital signature to attest to trustworthiness of the cryptographic key pair and to associate the digital signature with the certificate of conformance. The certificate of conformance is a data structure including protocols, a timestamp of attestation, and metadata of the user device 102 such as information about a creator of the user device 102. The private key signs the public key and associates the certificate of conformance with the public key creating the digital signature. In an embodiment, the certificate of conformance is embedded in an operating system of the user device 102 by a creator of the user device 102. The certificate of conformance binds the user device 102 with the cryptographic key pair creating the key binding. The public key signed by using the certificate of conformance indicates that the public key belongs to the user device 102 that complies with the protocols mentioned in the certificate of conformance. The secure element 404 sends the attestation to the server 206.

In one embodiment, the server 206 receives the attestation from the user device 102 via a security API of the user device 102. Examples of the security API include, but are not limited to, an integrity API for an Android™ device, and an app attest API for iOS devices. The server 206 is also associated with Google or Apple services. In an embodiment, the server 206 determines if the user device 102 is cracked. A cracked device is not secure, and the public key can be extracted from the cracked device. The security API of the cracked device also becomes accessible by brokers. The server 206 analyzes the attestation provided by the user device 102 to identify the cracked device.

The certificate analyzer 406 validates the certificate of conformance by checking whether the certificate of conformance exists in the pre-approved certificate authority repository. The attestation is considered valid when the certificate of conformance exists in the pre-approved certificate authority repository. When the attestation is validated, the server 206 links the resource allocating service 402 to the user device 102, which allows the resource allocating service 402 to extract the digital signature, public key, or other data from the user device 102.

When attestation is validated, the pattern detector 408 starts recording and analyzing usage of the cryptographic key pair. The pattern detector 408 invalidates the cryptographic key pair when an irrational pattern exhibited by the user device 102 is detected, such as when multiple keys are created by the secure element 404, the user device 102 does not respond to security updates, or the certificate of conformance gets excluded from the pre-approved certificate authority repository. In an embodiment, the pattern detector 408 sets a threshold for a security level. The pattern detector 408 then analyzes various metrics such as the usage of the cryptographic key pair, to determine the security level of the user device 102 and compares the security level with the threshold. The pattern detector 408 invalidates the cryptographic key pair or restricts the account of the user on the resource allocating service 402, when the security level is below the threshold.

Upon successful validation of the user device 102, the server 206 signals the resource management system 202 to allocate the selected resource to the user device 102 and generate the token 310 against the allocated resource. The resource management system 202 sends a message to the user device 102 via the resource allocating service 402. The message varies every time the resource is requested, and can include the event id, device id, or an identifier of the selected resource. The private key in the secure element 404 signs the message and creates the digital signature. The identity of the user device 102 is embedded in the digital signature. Based on the identity of the user device 102, the resource management system 202 identifies that the private key of the user device 102 is used to sign the message.

In an embodiment, the resource management system 202 allows the secure applications 410 to access data from the user device 102. The resource management system 202 maintains a list of the secure applications 410. The secure applications 410 are developed on a software development kit (SDK) of the server 206. The secure applications 410 may be the applications of an entity owning the resources, or event organizers. The secure applications 410 can also keep a track of the available and allocated resources, and may grant the event resources to some specific users. When the secure applications 410 allocate the resources or access the data from the user device, the server 206 is notified.

When the user device 102 is attested, and the resource allocating service 402 receives the digital signature from the user device 102, the resource management system 202 embeds the digital signature and the resource payload in the token 310. In an embodiment, the digital signature includes the metadata identifying the origin of the secure element 404. The server 206 links the resource allocating service 402 to the user device 102, allowing only the user device 102 to extract the digital signature and generate the token 310. When the attestation of the user device 102 fails, for example when the certificate of conformance is invalid or untrusted, the resource allocating service 402 generates a temporary token against the selected resource and the temporary token is added to the wallet 412 of the user device. In an embodiment, the wallet 412 is a digital wallet. The temporary token is validated at the scanning terminal, after which the user renders the resource rate and accesses the event. The user device 102 is not allowed to use the resource allocating service 402 for rendering the resource rate and getting the token 310.

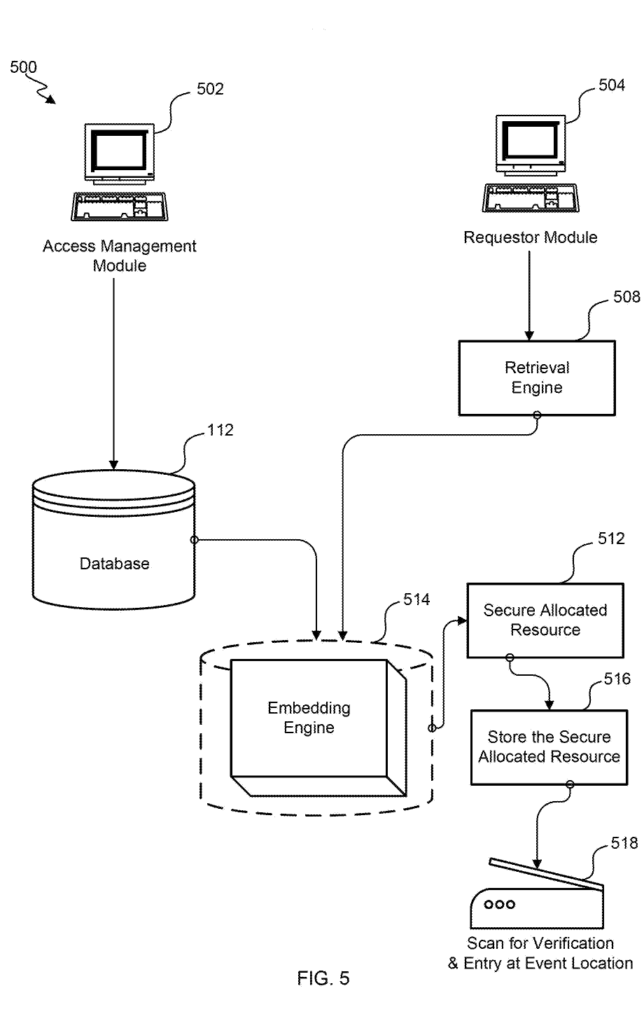

Referring next to FIG. 5, an embodiment 500 of the access management system 208 designed to securely manage the issuance, storage, and verification of the event resources is described. The embodiment 500 of the access management system 208 integrates several interconnected components that work in unison to enable that tokens are securely generated, stored, and verified at the event location, preventing the unauthorized access and resource fraud. The embodiment 500 of the access management system 208 includes an access management module 502, the database 112, a requestor module 504, a retrieval engine 508, a secure allocated resource 512, and an embedding engine 514.

In one exemplary embodiment, the access management module 502 serves as the primary controller for the entire token generation process. The access management module 502 dynamically adjusts access rights of the resources based on real-time event conditions including a change in resource availability, user authentication, and/or security alerts. The access management module 502 is responsible for coordinating the various functions required to validate the token 310. The access management module 502 interacts with the requestor module 504. The requestor module 504 is installed on the user device 102 and initiates the request for token validation when the user attempts to gain entry to the event.

The access management system 208 is connected to the database 112. The database 112 is communicatively coupled to the server(s) 206. The token 310 and the public key are stored in the database 112. The database 112 securely stores at least the public key associated with the token 310 and issuance record for the token 310. This database 112 acts as a secure repository, holding relevant data of the allocated resource, ensuring that the embodiment 500 of the access management system 208 can efficiently retrieve and validate the token 310 when required. The database 112 stores an immutable record of transactions occurring while allocating and validating the selected resource. The database 112 confirms that the issuance of the token 310 and associated data are unalterable post-issuance.

Further, the embodiment 500 of the access management system 208 also features the retrieval engine 508, which is important for the token verification process. The retrieval engine 508 retrieves the digital signature from the requestor module 504 on the user device 102. This digital signature is created using the private key stored on the user device 102 and is integral to the token verification process. This embodiment distinguishes between two types of allocated resources: a basic allocated resource, which includes the public key and the resource payload, such as in the form of the barcode and is stored in the database 112, and a secure allocated resource 512 with the token 310 having an embedded digital signature and the resource payload, generated exclusively on the user device 102 during the rendering step. Further, the secure allocated resource 512 with the digital signature is stored on the user device 102 at 516 and is not stored in the database 112.

Further, the embedding engine 514 processes the basic allocated resource, embedding the public key and the resource payload to establish a secure association with the user device 102. This dual architecture enhances the system’s reliability and security, with the basic allocated resource stored in the database 112 to enable redundancy and accessibility, while the secure allocated resource 512 with the digital signature on the user device 102 enables secure, device-specific verification during the authentication process.

In this regard, when the user arrives at the event location, the secure allocated resource is scanned for verification and entry at the event location at 518. The access management module 502 retrieves the relevant information from the database 112 and verifies the secure allocated resource 512 by cross-referencing the token 310 with the stored public key and digital signature. The digital signature can be extracted from the scanned barcode for validation against the stored public key. The verification process enables that the basic allocated resource associated with the token 310 is authentic and has not been tampered with. In case the verification is successful, the user is granted access to the event. If the verification fails, access is denied, thereby preventing unauthorized entry.

In one exemplary embodiment, the embodiment 500 of the access management system 208 is utilized for the secure issuance and binding of the event resources. The resource payload and public key for the basic allocated resource are then stored in the database 112. This embodiment differentiates between the basic allocated resource and the secure allocated resource 512. Specifically, the basic allocated resource is stored in the database 112 to enable redundancy. The digital signature, however, is generated solely on the user device 102 during the rendering process using the private key, and this digital signature is embedded into the token 310 by the embedding engine 514, creating the secure allocated resource 512 that exists exclusively on the user device 102.

In another exemplary embodiment, the access management system 208 is optimized for real-time token verification at the event locations. When the user arrives at the event location, the secure allocated resource 512 is scanned at the event location 518. In response, the access management system 208 retrieves the basic allocated resource and the associated public key from the database 112. Verification is then performed by validating the scanned token, against the stored public key. This process is designed to be fast and efficient, ensuring that large numbers of attendees can be processed quickly while maintaining high security.

In another exemplary embodiment, the present disclosure provides enhanced resource security by integrating the digital signature into the token 310 during the rendering process. During the issuance of the token 310, only the basic allocated resource and its associated public key are stored in the database 112. The digital signature is subsequently generated exclusively on the user device 102 during the rendering step, utilizing the private key, and is refreshed such as at 15-second intervals to maintain a high level of security. This secure allocated resource 512, with the dynamically generated digital signature embedded in the token 310 alongside the public key, is stored solely on the user device 102, ensuring a matchless and device-specific association that protects the secure allocated resource 512 from unauthorized duplication or misuse.

In another exemplary embodiment, the embodiment 500 of the access management system 208 implements a redundant storage strategy for the secure allocated resources 512 to enhance reliability. After the resource payload is generated and embedded, the resource payload and the public key, are stored at two locations: on the user device 102 and in the database 112. This dual-storage approach enables that even if one storage location becomes compromised or inaccessible, the resource payload and public key can still be retrieved and verified from the other location.

In another exemplary embodiment, the access management module 502 is designed to integrate seamlessly with existing access control systems used by the event locations. The secure allocated resource 512, embedded with the public key and the digital signature, can be scanned and verified using the existing access control infrastructure at the event location. The embodiment 500 of the access management system 208 enables compatibility by providing APIs and communication protocols that allow for easy integration with various third-party access control systems.

In yet another embodiment, the embodiment 500 of the access management system 208 is specifically configured for the high-demand events where resource security is paramount. The tokens produced are not only distinct but also time-sensitive, meaning they are valid for a short period before being refreshed. This ensures that even if the token 310 is intercepted, it is not reused by an unauthorized party. The embedding engine 514 embeds the time-sensitive token with the public key, digital signature, and resource payload, creating the secure allocated resource 512 that is both tamper-proof and resistant to forgery.

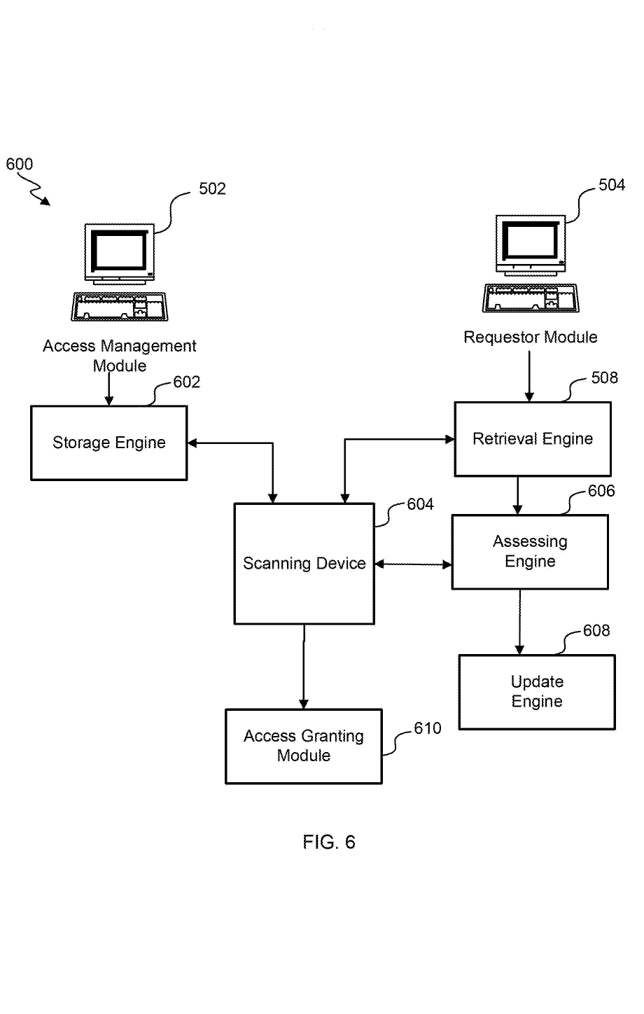

Referring next to FIG. 6, illustrates a token verification method 600 for the secure allocated resource 512. The token verification method 600 allows authentication of the token 310 and allows authentic users to access the event. The token verification method 600 performs authentication by leveraging multiple layers of security and real-time verification processes. The token verification method 600 includes a storage engine 602, a scanning device 604, an assessing engine 606, an update engine 608, and an access granting module 610 that operate in conjunction with the access management module 502 and the requestor module 504.

The requestor module 504 of the user device 102 initiates the request for validating the secure allocated resource 512. In an embodiment, the requestor module 504 initiates the request when the user device 102 is at the scanning terminal of the event location. The requestor module 504 signals the access management module 502, and the access management module 502 then starts the validation process.

The access management module 502 communicates with the server 206 to determine whether the user device 102 is secure. The access management module 502 signals the retrieval engine 508 when the user device 102 is secure. The resource management system 202 generates the token 310 at the resource allocating service 402 in the user device 102 associated with an attested cryptographic key pair. The attested cryptographic key pair is the one for which the attestation is successfully verified by the server 206. While the resource management system 202 generates the temporary token and adds the temporary token to the wallet 412 of the user device 102 when the user device 102 is not secure. The access management module 502 is responsible for retrieving security information of the user device 102 from the server 206. The access management module 502 is also responsible for overseeing crucial processes, including the generation, validation, and storage of the cryptographic key pair and the resource information.

The access management module 502 is directly connected to the storage engine 602, which serves as a secure repository for the event-specific data, including event ids and the corresponding payload for the resources. The access management module 502 analyzes the tokens and the temporary tokens in separate queues. The two queues are separately analyzed at the scanning terminal by the scanning device 604. The storage engine 602 maintains basic allocated resources and the resource payload including the public keys of the user devices 102 used to validate secure allocated resources. The resource allocating service 402 causes the data related to the allocated resource to be stored in the storage engine 602.

The scanning device 604 is located at the scanning terminal. Examples of the scanning device 604 include, but are not limited to an Aztec barcode reader, and a pdf417 barcode scanner. In an embodiment, when the user device 102 has the token 310 generated by the resource allocation service 402, the scanning device 604 allows the user device 102 to display the token 310 within a focus area of the scanning device 604. When the user device 102 displays the token 310, the retrieval engine 508 of the scanning device 604 extracts the resource payload and the digital signature from the token 310. The digital signature is a crucial element of the token verification method 600, as it enables that the verification request originates from an authorized user.

In an embodiment, the scanning terminal is configured to generate a real-time access log. The scanning terminal analyzes an outcome of token validation attempts, and records a count of success and failure of token validation for an individual user. The scanning terminal can restrict a user if the token validation attempts exceed an allowed number of the token validation attempts. The scanning terminal further transmits the real-time access log to the server 206 for audit and security purposes.

In another embodiment, when the user device 102 is not secure, the resource management system 202 adds the temporary token to the wallet 412 of the user device 102. The scanning device 604 interacts with the wallet 412 of the user device 102 using a near field communication (NFC) protocol. The NFC protocol allows communication between the devices that are in short range. The requestor module 504 of the user device 102 generates an electromagnetic field to initiate the validation process. The scanning device 604 receives the electromagnetic field and is connected to the user device 102. The scanning device 604 and the wallet 412 exchange messages with one another. The messages may include the event id and a device id of the scanning device 604 and the user device 102. The scanning device 604 extracts the resource payload from the temporary token.

The retrieval engine 508 works in tandem with the assessing engine 606 to validate the token 310 and the temporary token. The assessing engine 606 verifies the digital signature and resource payload embedded within the token 310 against the public key and data stored in the storage engine 602. By using the public key, the digital signature is decoded and the message embedded in the digital signature is matched. The assessing engine 606 analyzes the authenticity of the temporary token and requests the user device 102 to render the resource rate. This validation process ensures that the secure allocated resource 512 is cryptographically bound to the authorized user device, preventing tampering or misuse.

The assessing engine 606 connects to the update engine 608, which handles the dynamic update of the secure allocated resource 512. During re-transfer of the resource, the update engine 608 invalidates the existing token 310 and issues the new token associated with the new owner. The update engine 608 also updates the verification information in the storage engine 602 which can be reused by the token verification method 600 or the user. When the digital signature is not verified, the update engine 608 signals the pattern detector 408 to store the relevant information. The pattern detector 408 uses the information in later scenarios, such as when the user device 102 requests the resource next time. In an embodiment, if the verification fails, the token 310 is not generated for the user device 102 when the user device 102 requests the resource next time. Alternatively, the temporary token is generated in the wallet 412 of the user device 102.

Based on the verification results, the access granting module 610 either grants or denies access. In a case where the public key and digital signature are successfully validated, the access granting module 610 allows the user to access the event. For example, the access granting module 610 opens a gate or removes obstacles to allow the user to access the event. In a case a discrepancy is detected, the access granting module 610 restricts the user from accessing the event. In an embodiment, the account of the user on the resource allocating service 402 is restricted, when the token 310 is invalid.

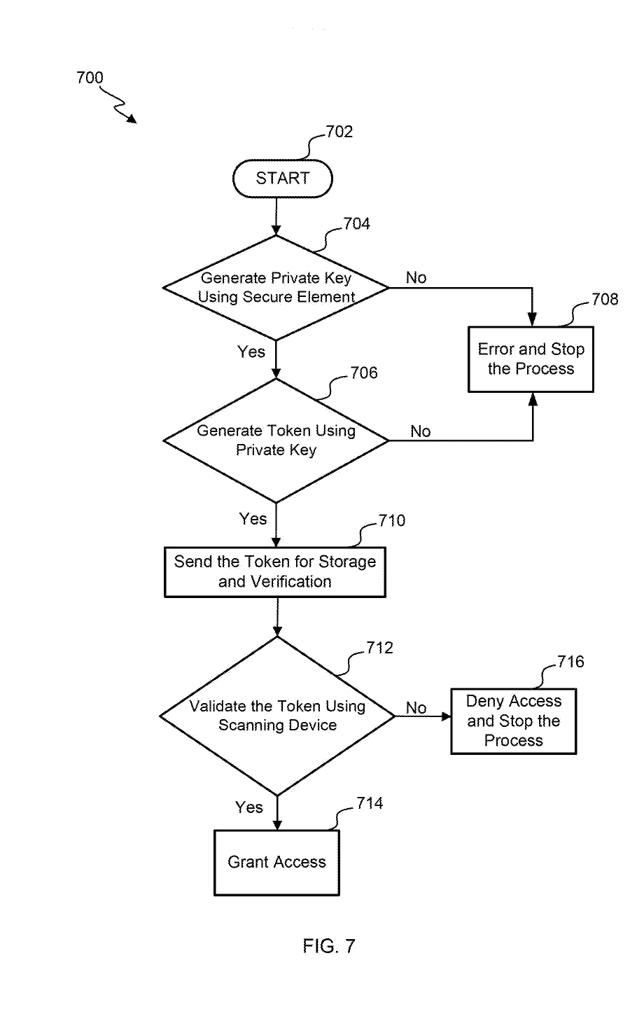

Referring next to FIG. 7, an authentication method 700 designed for generating a private key, creating the token 310, and verifying access at the event location is illustrated. In one embodiment, the authentication method 700 leverages cryptographic techniques, secure key management, and real-time validation to enable that an individual secure allocated resource is matchlessly tied to the user to significantly reduce a risk that the secure allocated resource 512 is fraudulently duplicated or tampered with. This multi-step process involves the interaction of several components within the resource allocating service 402 and the server 206 infrastructure to generate, store, and verify the secure allocated resources.

In one exemplary embodiment, the authentication method 700 begins at step 702 when the user opens the resource allocating service 402 on the user device 102. The resource allocating service 402 is designed to interface with the secure element 404 of the user device 102 and the server 206 at the backend to manage the secure generation and storage of the event resources. This initial step is crucial as it sets the stage for the subsequent security measures that will be applied to the resource.

At step 704, the authentication method 700 involves generating the private key of the cryptographic key pair using the secure element 404 of the user device 102 or reusing an existing private key previously generated by the secure element 404. The secure element 404 is a dedicated hardware-protected module designed to store and manage cryptographic keys in a tamper-resistant environment. The private key generated at this step is important for creating a secure and distinct link between the selected resource and the user. The private key is utilized to sign the message sent by the resource allocating service 402 for verification.

The authentication method 700 generates the token 310 for the selected resource in the following steps. If the private key is successfully generated, the authentication method 700 moves forward to step 706. However, if there is an issue in generating the private key, the authentication method 700 proceeds to step 708, where an error message is displayed, and the process is halted to prevent any further actions that could compromise resource security.

In this regard, at step 706, the authentication method 700 utilizes the private key generated in the previous step to create a dynamic token. The token 310 is dynamically generated, meaning it changes at the predefined intervals or in response to specific triggers, such as a request from the server 206 or user interaction. The dynamic nature of the token 310 enables that even if the token 310 is intercepted, it cannot be reused by unauthorized parties. The token 310 includes a digital signature computed using the private key and a resource payload identifying the selected resource, making the digital signature matchlessly tied to the user’s identity and device. If the token 310 is generated successfully, the authentication method 700 continues to step 710. In case the token 310 generation fails, the authentication method 700 may retry the operation or proceed to step 708 to display the error message and halt the authentication method 700.

Further, once the token 310 is generated, the step 710 involves sending the token 310 and associated data from the user device 102 to the server 206 for storage and later verification. The server 206, via the storage engine 602 or database 112, stores the issuance record, the resource payload, and the public key associated with the token 310 and perform basic consistency checks to confirm that the token 310 has been correctly formed and corresponds to the selected resource and event. If this transmission and storage of the token 310 succeed, the authentication method 700 advances to step 712. If an error occurs during transmission or storage, the authentication method 700 proceeds to step 708, where an error message is displayed and the process is stopped.

At step 712, the user arrives at the event location and presents the secure allocated resource 512 for validation. The scanning device 604, which is equipped with scanning and verification capabilities, reads the token 310 from the user device 102. The scanning device 604 then communicates with the assessing engine 606 to verify the resource payload and the digital signature using the stored public key and issuance record retrieved from the storage engine 602.

If the token 310 is successfully verified by the assessing engine 606 at step 712, the authentication method 700 advances to step 714, where access to the event is granted. If an issue occurs during verification, the authentication method 700 may either retry the verification or display the error message at step 716, ensuring that only valid tokens are accepted.

In case the token 310 is validated successfully at the step 714, the authentication method 700 grants access to the event. This step signifies that the secure allocated resource 512 has been verified as authentic and that the token 310 matches the record stored on the storage engine 602. The scanning device 604 communicates with the access granting module 610 to unlock the access point, allowing the user to enter the event location. The successful completion of this step enables that authorized individuals with valid secure allocated resources or token 310 gain entry to the event.

In one exemplary embodiment, in case the validation fails at step 712, access to the event is restricted. This could happen for several reasons, such as the token 310 being expired, tampered with, or not matching the records stored on the storage engine 602. The scanning device 604 alerts the user that the token 310 is invalid, and the authentication method 700 halts the process to prevent unauthorized entry.

The process concludes, marking the end of the ticketing operation. Depending on the outcome of the previous steps, the process either ends with the user successfully entering the event or being denied access due to an invalid resource. This enables that the resource management system 202 operates efficiently and securely, providing a reliable method for managing event access.

In another exemplary embodiment, the authentication method 700 is designed to generate the secure allocated resource 512 using dynamically generated tokens and the cryptographic key pair. The process starts with the user opening the resource allocating service 402, where the private key is generated using the secure element 404 of the user device 102. This private key is then used to create the token 310, which changes at regular intervals, ensuring that the token 310 cannot be reused or forged.

In one exemplary embodiment, the authentication method 700 includes enhanced security measures through error handling and retry mechanisms. At an individual step, such as private key generation, dynamic token creation, and verification, the authentication method 700 monitors for potential errors. If an error occurs, the authentication method 700 may retry the operation or display the error message, prompting the user to take corrective action.

In one exemplary embodiment, the authentication method 700 is optimized for high-security events by generating time-sensitive dynamic tokens that refresh the digital signature at predefined intervals, making the token 310 nearly impossible for counterfeiters to replicate the secure allocated resource 512.

In another exemplary embodiment, the authentication method 700 is designed to adapt to dynamic event environments. The resource allocating service 402 monitors user activity and environmental factors to determine the optimal time for generating or refreshing the token 310. The token 310 is then validated at the event location.

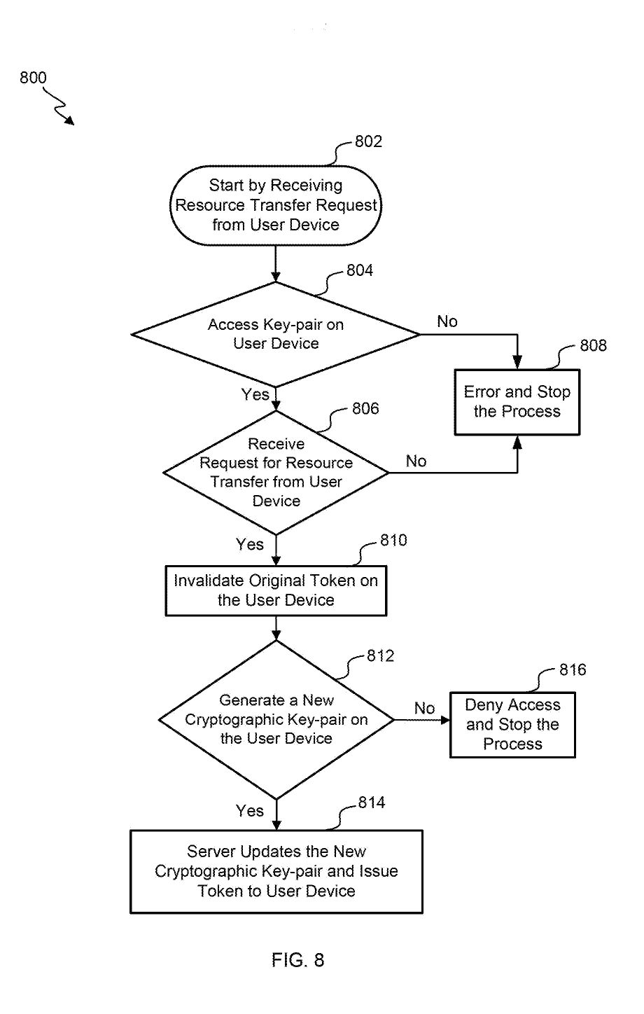

Referring next to FIG. 8, a resource transfer process 800 between the user device 102-1 and the user device 102-2 is illustrated. The resource transfer process 800, outlined in the flowchart, enables that the allocated resource is securely tied to the user device 102-2 and that the original token is invalidated to prevent misuse.

In one exemplary embodiment, the resource transfer process 800 begins at step 802 with the initiation of the resource transfer request by the user on the user device 102-1. At step 804, the resource management system 202 accesses the cryptographic key pair, including the private key and the public key, on the user device 102-1 or reuse existing cryptographic key pair in case the cryptographic key pair. The cryptographic key pair can be reused for getting the resources in future. The private key is securely stored in the secure element 404, ensuring that it cannot be extracted or tampered with. The public key associated with the cryptographic key pair will be used later in the process to rebind the allocated resource to the user device 102-2. If the cryptographic key pair is successfully accessed, the resource transfer process 800 continues to step 806. However, if there is an issue in accessing the cryptographic key pair, the resource transfer process 800 moves to step 808, where the error message is displayed, and the process is halted to prevent further actions that could compromise the resource security, and the resource is kept bound to the user device 102-1.

At step 806, the resource transfer process 800 involves receiving the resource transfer request from the user device 102-2. This step is initiated by the user on the user device 102-2, indicating their intention to receive the transferred resource. The user device 102-2 communicates, for example via the API gateway 104, with the resource management system 202 that is already processing the transfer request from the user device 102-1, ensuring that both devices are synchronized for the secure transfer.

Further, at step 810, the resource transfer process 800 invalidates the original token on the user device 102-1. This step ensures that the secure allocated resource 512 can no longer be used on the user device 102-1 once the transfer is initiated. Invalidating the token 310 is a security measure to prevent duplicate resources from being used. If the token 310 is successfully invalidated, the resource transfer process 800 proceeds to step 812. If there is an issue with invalidating the token 310, the resource transfer process 800 may retry the operation or proceed to step 808, where the error message is displayed, and the process is halted.

At step 812, the user device 102-2 generates its own cryptographic key pair using a secure element corresponding to the secure element 404, or reuses the existing cryptographic key pair, similar to the process in step 804. This cryptographic key pair includes the second private key 324, which is securely stored on the user device 102-2, and a corresponding public key. The user device 102-2 then requests issuance of the new token associated with its own public key and a digital signature generated using the second private key 324. This step enables that the resource is now securely bound to the user device 102-2 and its distinct cryptographic identity.

Following the successful generation or reuse of the cryptographic key pair and the resource transfer request, step 814 involves sending the request to the server 206. The server 206 plays a role in updating the public key associated with the resource and issuing the new token bound to the user device 102-2. If the server 206 successfully processes this request, the resource transfer process 800 completes the resource transfer. However, if the server 206 denies the request or if any issues arises, the resource transfer process 800 moves to step 816, where access is denied, and the process is halted to prevent unauthorized resource transfers.

Further, at step 814, after successful server processing, the server 206 updates the public key associated with the resource in its database and issues the new token bound to the user device 102-2. This enables that the resource is securely transferred, and the user device 102-2 is now the sole holder of the allocated resource, ready for use at the event location.

In one exemplary embodiment, the resource transfer process 800 facilitates the secure transfer of the event resources from one device to another by binding the resource to the cryptographic key pair. The resource transfer process 800 begins with accessing the cryptographic key pair on the user device 102-1, where the private key is securely stored in the secure element 404. The token 310 is invalidated before the user device 102-2 generates its own cryptographic key pair and requests the new token. The server 206 updates the public key associated with the resource and issues the new token bound to the user device 102-2.

In another embodiment, the resource transfer process 800 emphasizes real-time token invalidation and rebinding during the resource transfer process 800. Once the resource transfer is initiated, the original token is immediately invalidated on the user device 102-1, preventing any further use. The user device 102-2 then generates its cryptographic key pair or reuses the existing cryptographic key pair and requests the new token, which is bound to its distinct public key. The server 206 updates the token 310 in real-time, ensuring that the transfer is secure and that the new device holds the valid secure allocated resource.

In a further embodiment, the resource transfer process 800 incorporates error handling and retry mechanisms to enhance the reliability of the resource transfers. At an individual step, such as key pair generation, token invalidation, and server processing, the resource transfer process 800 monitors for potential errors. If an error occurs, the resource transfer process 800 may retry the operation or display the error message, prompting the user to take corrective action.

In another embodiment, the resource transfer process 800 leverages immutable token binding to enhance security during the resource transfers. Once the secure allocated resource 512 is transferred and bound to the user device 102-2, the server 206 records the transfer in an immutable format, for example in an append-only transaction log of the database 112, preventing any unauthorized changes. This record enables the resource transfer history is tamper-proof and can be audited.

In yet another embodiment, the resource transfer process 800 is designed to adapt to dynamic environments where the resource transfers may occur frequently or under varying conditions. The resource transfer process 800 can dynamically adjust the frequency of key pair generation, resource invalidation, and server updates based on user behavior or environmental factors.

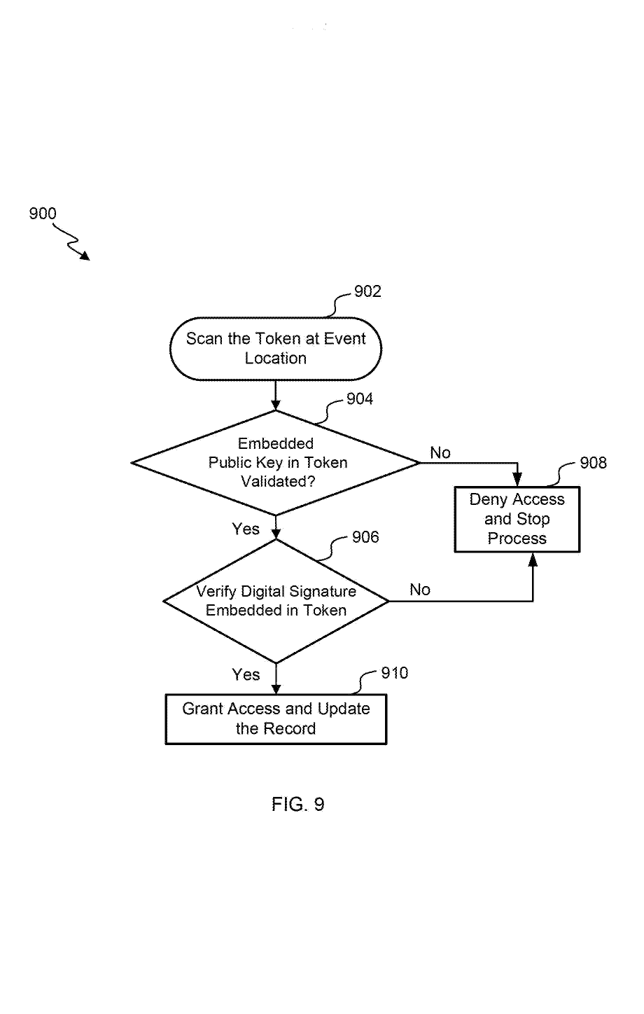

Referring next to FIG. 9, a token verification process 900 at the event location, validating the public key and the digital signature before granting access, is illustrated. The token verification process 900 leverages embedded public keys and digital signatures within the token 310 to authenticate the token 310 and grant or deny access based on the validation results.

In one exemplary embodiment, the token verification process 900 begins at step 902 when the user presents the secure allocated resource 512 at the event location. The secure allocated resource 512, typically stored on the user device 102, is displayed for scanning by the scanning device 604. This step is the initial point of interaction between the user and the access management system 208, setting the stage for the token verification process 900.

At step 904, after the token 310 has been scanned by the scanning device 604 on the secure allocated resource 512, the token verification process 900 validates the embedded public key contained within the token 310. The token 310 contains information, including the embedded public key and digital signature, which are important for validating the token 310 for authenticity. If the token 310 is successfully scanned, the token verification process 900 proceeds to the next step. However, if the scanning process encounters an issue, such as an unreadable token, the token verification process 900 prompts a retry of the scan to confirm that the resource can be properly evaluated.

Further, once the token 310 is successfully scanned, the token verification process 900 moves to step 906, where the token verification process 900 validates the embedded public key contained within the token 310. If the public key is valid, the token verification process 900 continues to step 908. If the public key is found to be invalid, indicating a potential issue with the resource authenticity or integrity, the token verification process 900 proceeds to step 908, where access is denied, and the token verification process 900 is halted to prevent unauthorized entry.

Following the successful validation of the public key, step 910 involves verifying the digital signature associated with the token 310. The digital signature, which was generated using the private key during the issuance of the token 310, is decrypted by the public key, and the message is extracted. The message has to match the message stored in the storage engine 602. This step enables that the digital signature is associated with the correct public key and the token 310 has not been tampered with since its creation. If the digital signature is valid, the token verification process 900 grants access allowing the user to enter the event. Alternatively, in case the digital signature is invalid, the token verification process 900 denies access, ensuring that genuine and unaltered resources are accepted.

Finally, the token verification process 900 concludes marking the end of the token validation operation. Depending on the results of the previous steps, the token verification process 900 either ends with the user successfully gaining access to the event or being denied entry due to an invalid token.

In one another embodiment, the offline validation process enables that the resource security is maintained even in the absence of a network connection, providing a reliable method for managing access to the event locations.

In one exemplary embodiment, the token verification process 900 enables offline token validation by embedding public keys within the token 310. When the user presents the token 310 at the event location, the token 310 is scanned by the scanning device 604, and the embedded public key is validated. If the public key matches the expected key for the event, the token verification process 900 proceeds to verify the digital signature associated with the token 310.

In another embodiment, the token verification process 900 focuses on enhancing security through the verification of digital signatures embedded in the token 310. After the public key is validated, the token verification process 900 checks the digital signature to ensure that the token 310 has not been tampered with since its issuance. The message in the digital signature, which is signed by the private key used during token generation, wants to be extracted by the public key embedded in the token 310.

In a further embodiment, the token verification process 900 incorporates error handling and a rescan mechanism to enable reliable resource validation. If the token 310 is not scanned correctly on the first attempt, the token verification process 900 prompts the user to retry scanning. This enables minor issues, such as an unclear token or a momentary glitch in the scanning device 604, do not prevent the token 310 from being validated.

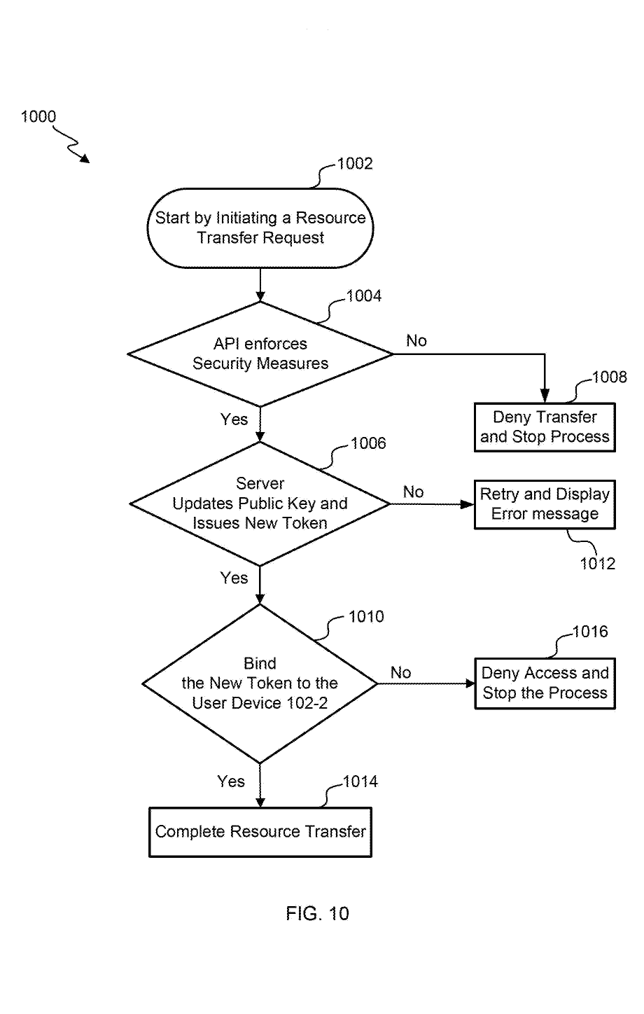

Referring next to FIG. 10, a binding process 1000 for the resource transfer, including API security enforcement and binding the new token to the user device 102-2, is illustrated. The binding process 1000 enables that the resource transfer performed through the secure applications 410, maintains the security and integrity of the resource management system 202, thus preventing unauthorized access and ensuring that the resource remains securely bound to the user device 102-2.

In one exemplary embodiment, the binding process 1000 begins at step 1002 when the user initiates the resource transfer request on the secure application 410. This step involves the user opting to transfer the resource through the secure application 410, which mandates secure communication between the secure application and the server 206.

At step 1004, the API gateway 104 enforces security measures to confirm that the resource transfer request is legitimate and that the communications between the secure applications 410 and the server 206 are secure. The API gateway 104 acts as a gatekeeper, applying important security protocols, such as authentication, encryption, and validation on the resource transfer request. If the security measures are successfully enforced, the binding process 1000 continues to step 1006. However, if there is a failure in enforcing these measures, the binding process 1000 proceeds to step 1008, where the resource transfer is denied, and the binding process 1000 is halted to prevent any potential security breaches.

In this regard, step 1006 involves the server 206 for updating the public key associated with the token 310 and issuing the new token that reflects the resource transfer. The server 206 plays a role in ensuring that the resource is securely transferred to the user device 102-2 by either generating the second public key 326 or reusing the existing cryptographic key pair and associating it with the new token. This step enables that the secure allocated resource 512 is no longer bound to the user device 102-1 and is, alternatively, securely tied to the user device 102-2. If the server 206 successfully updates the public key and issues the new token, the binding process 1000 advances to step 1010. If there is an issue during this step, the binding process 1000 may retry the operation or proceed to step 1012, where the error message is displayed, and the binding process 1000 is halted.

At step 1010, the binding process 1000 attempts to bind the new token to the user device 102-2 by associating the secure allocated resource 512 with one or more unique identifiers of the user device 102-2, such as the cryptographic key pair. If the binding is successful, the binding process 1000 proceeds to step 1014 in accordance with the rules governing the resource transfer operations, devoid of immediate enforcement of device binding. Further, binding of the secure allocated resource 512 to the user device 102-2 does not occur at this stage but is deferred to the rendering process.

Furthermore, during the rendering process, when the user attempts to access or view the new token, the binding process 1000 enforces binding by associating the secure allocated resource 512 with the distinct identifiers of the user device 102-2, such as the cryptographic key pair. In case the binding process 1000 is successful, the user is granted access to the event location, and the new token is rendered for use. At block 1016, in case the binding process 1000 fails during rendering, the server 206 prevents the secure allocated resource 512 from being displayed or used, ensuring that the resource remains secure and cannot be accessed by unauthorized devices. This approach maintains the integrity of the resource while allowing the resource transfer operation to succeed.

In another embodiment, the binding process 1000 emphasizes real-time security measures during the resource transfer process while deferring binding enforcement to the rendering stage. Upon initiation of the resource transfer request through the secure applications 410, the API gateway 104 implements security protocols, including encryption and authentication, to verify the legitimacy of the request. The server 206 facilitates the transfer of the resource by updating the relevant transaction details by storing the issuance record for the token in the database 112, adhering to predefined transfer rules.

Further, binding of the resource to the user device 102-2 is not enforced during the resource transfer process. Alternatively, enforcement occurs at the rendering stage, when the new user attempts to access the token 310. At that time, the binding process 1000 confirms the token 310 is cryptographically bound to the user device 102-2, using a mechanism, such as the generation and validation of the cryptographic key pair, thereby securing the resource for subsequent use.

In a further embodiment, the binding process 1000 incorporates error handling and retry mechanisms to enable the reliability of the resource transfer process. If an error occurs during any step, such as enforcing security measures, updating the public key, or binding the resource to the user device 102-2, the binding process 1000 may retry the operation or prompt the user to take corrective action.

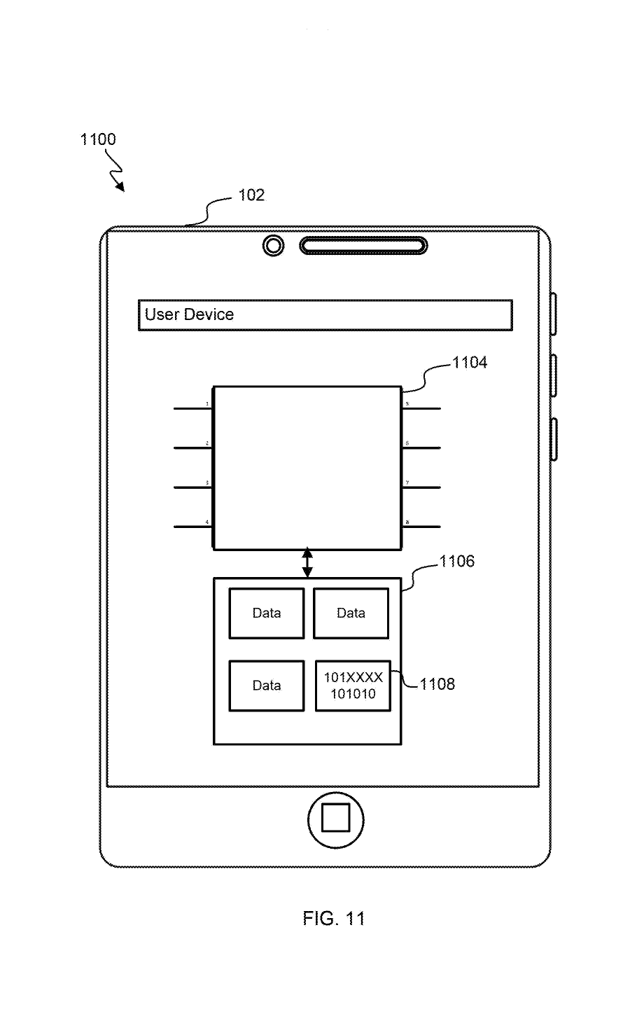

Referring to FIG. 11 represents an internal storage architecture 1100 including the user device 102 with storage modules storing a private key 1108 for the secure allocated resource 512 management. The internal storage architecture 1100 comprises the user device 102 equipped with a processor 1104 and an internal storage 1106. The processor 1104 serves as the central processing unit of the user device 102, executing instructions and managing the overall operation.

In one exemplary embodiment, the present disclosure provides the internal storage architecture 1100 comprising multiple storage modules, including a secure element 404 implemented as a chip specifically dedicated to storing sensitive cryptographic information, such as the private key 1108.

This secure element 404 is an isolated hardware component within the user device102, physically separated from the device’s main storage, thereby providing enhanced security by safeguarding the private key 1108 from unauthorized access or exposure to external threats. The private key 1108, stored exclusively within this secure element chip, functions as the distinct cryptographic identifier for the user device 102, enabling secure authentication of transactions and communications. By utilizing the private key 1108, the user device 102 generates digital signatures as part of a cryptographic key pair, including a corresponding public key, to verify the authenticity and integrity of data, ensuring that only authorized actions are permitted and executed securely.

In one exemplary embodiment, the internal storage architecture 1100 enables secure digital signature generation by using the private key 1108 stored within the secure element 404. Upon initiation of a transaction or communication by the user, the secure element 404 directly generates the digital signature using the private key 1108, which remains confined within the secure element 404 and is never exposed outside this isolated environment. The digital signature is subsequently appended to the data being transmitted, allowing the recipient to authenticate the sender’s identity and verify the integrity of the message. The internal storage architecture 1100 enables that the private key 1108 remains protected within the secure element 404, thereby enhancing the security of the digital signature generation process and safeguarding against unauthorized access.

In another embodiment, the internal storage architecture 1100 is used for managing cryptographic keys within the secure environment. The internal storage 1106 includes a secure memory region associated with the secure element 404 and securely stores the private key 1108, which the processor 1104 uses to authenticate transactions and to generate digital signatures for tokens and other resource-related data. This key management process enables that the key remains confidential and is used for authorized operations.

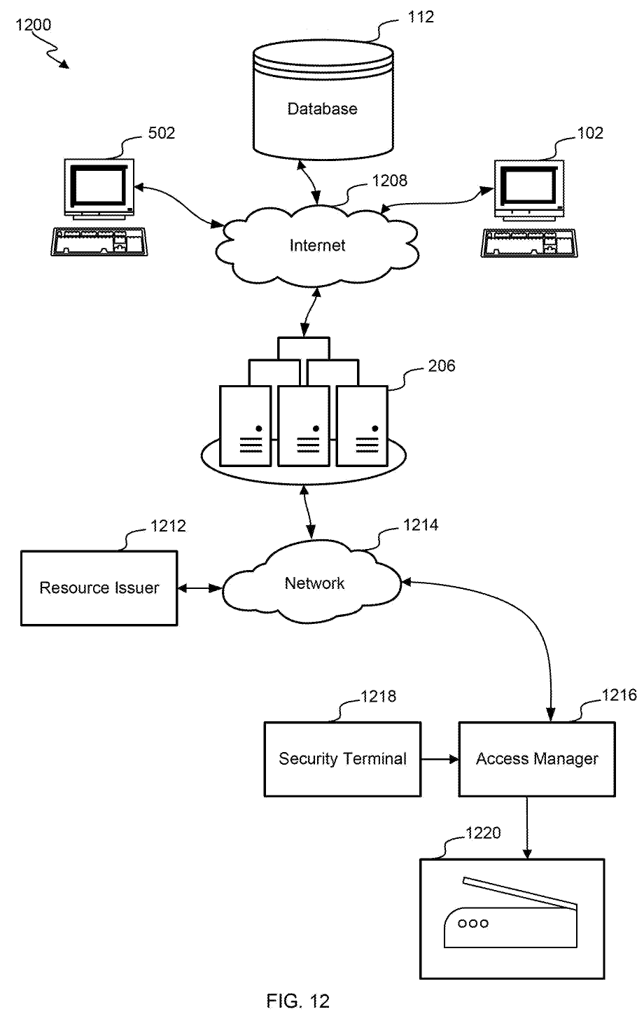

Referring next to FIG. 12, a network setup 1200 for resource issuance, highlighting the roles of a resource issuer 1212, a security terminal 1218, and the access management module 502 is illustrated. The network setup 1200 includes the database 112 configured to store resource-specific public keys that are crucial for securing the allocated resources. The cryptographic key pair includes a private key held in the secure element of the user device 102 and a corresponding public key stored in the database 112, which together are used to encrypt and authenticate the secure allocated resources, ensuring that they can be accessed and used by authorized users.

In one exemplary embodiment, the access management module 502 is central to the operation of the network setup 1200, which oversees the management and distribution of the access rights. The access management module 502 interacts with the user device 102, which initiates the requests for the resources or the access rights. The access management module 502 dynamically adjusts the access rights based on the real-time event conditions, including at least one of changes in resource availability, user authentication, and security alerts. The user device 102 is connected to the access management module 502 via an internet connection 1208, enabling it to exchange information with other components of the network setup 1200, including the server 206.

The server 206 plays a primary role in the resource issuance in this embodiment. The server 206 is connected to the resource issuer 1212 that possesses its own key pair for securing the resources. This connection is facilitated through a network 1214, which enables secure communication between the resource issuer 1212 and the server 206. The server 206 manages the distribution of the resources, ensuring that they are securely bound to the intended user and their device.

An access manager 1216 is communicatively coupled to the network 1214 and is responsible for processing information received from both the network and the security terminal 1218. The security terminal 1218 provides security information that the access manager 1216 uses to validate and process the resource requests.

At the event location, the secure allocated resource 512 is scanned at a scanning terminal 1220. The scanning terminal 1220 is designed to read and verify the security features embedded in the token 310, including any cryptographic signatures or key pair bindings. This scanning process enables that valid and authorized tokens grant access to the event location, maintaining the security and integrity of the event.

In particular, the network setup 1200 provides a comprehensive solution for managing and securing access to events, leveraging cryptographic key pairs, secure communication networks, and real-time validation processes to prevent unauthorized access and ensure that genuine tokens are used. The key pairs are generated on the user device using the secure element.

In one exemplary embodiment, the network setup 1200 facilitates the secure allocated resource 512 issuance and validation by utilizing from the public keys and issuance records stored in the database 112. The access management module 502 manages the distribution of these tokens, ensuring that an individual token is securely bound to the user device 102 through the cryptographic key pair. The resource is issued by the server 206, which interacts with the resource issuer 1212 over the network 1214. The secure allocated resource 512 is then validated at the event location using the scanning terminal 1220, ensuring that authorized resources grant access.

In another embodiment, the network setup 1200 emphasizes real-time access management to enhance event security. The access manager 1216 processes information from the network 1214 and the security terminal 1218 to evaluate token validation results and dynamically adjust access rights in real time. This real-time processing confirms that the resources are issued and validated based on the up-to-date security information, reducing the risk of fraud or unauthorized access. The network setup 1200 ability to process and validate resources in real-time makes it ideal for large-scale events where security is paramount.

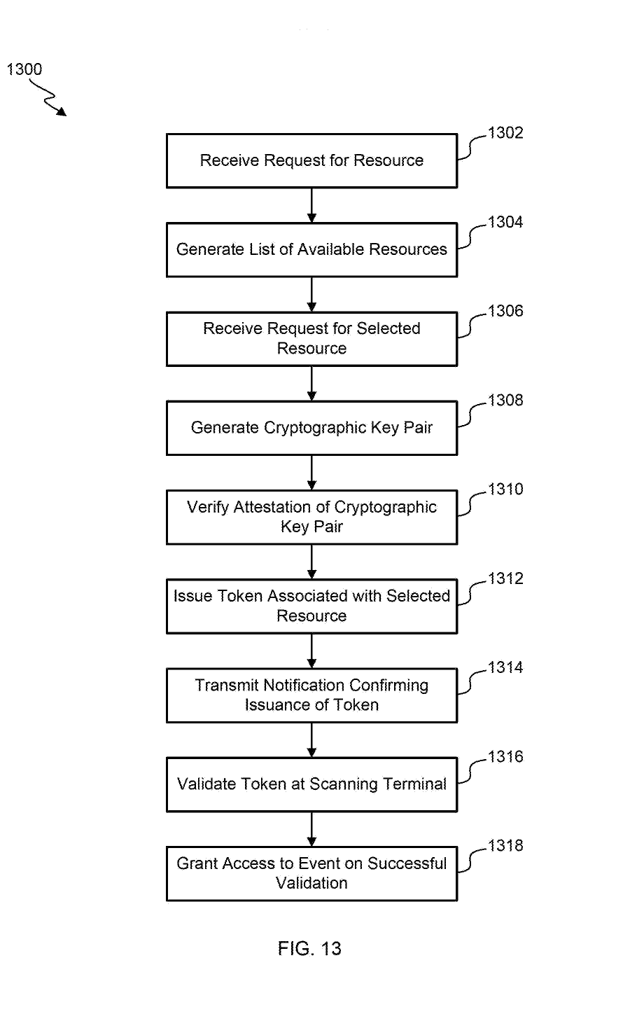

Referring next to FIG. 13, a method 1300 for generating and validating the event resources is illustrated. The method begins at step 1302, where the method 1300 involves receiving the request for the resource from the user device 102 associated with the user. The request is associated with the resource of the event, and the server 206 is responsible for receiving the request via the API gateway 104. At step 1304, the server 206 generates the list of the available resources on the resource allocating service 402. The server 206 analyzes the data in the database 112 and dynamically generates the list based on the real-time availability data. The user device 102 is then provided with event information, including seat maps, resource rate, and other relevant details, before the user selects the resource. This step is crucial for ensuring that the user is presented with up-to-date availability, preventing overbooking or selection errors. At step 1306, the user selects the resource from the list of available resources, and the server 206 receives the selected resource from the user device 102.

At step 1308, the server 206 requests the secure element 404 to generate the cryptographic key pair. The secure element 404 is the hardware-protected module in the user device 102. The secure element 404 generates the cryptographic key pair, including the public key and the private key 1108. The private key 1108 creates the digital signature by signing the public key using the certificate of conformance to attest to the trustworthiness of the cryptographic key pair.

At step 1310, the user device 102 sends the attestation of the cryptographic key pair, and the server 206 verifies the attestation of the cryptographic key pair. The server 206 verifies the attestation by validating the certificate of conformance and validating that the certificate of conformance is listed in the pre-approved certificate authority repository. The verification confirms that the cryptographic key pair originates from the secure and authorized user device. In an embodiment, the method 1300 requests identification via OAuth authentication to verify user identity. This step enables that the resource is tied to the correct individual, adding a baseline layer of security to the transaction. The OAuth authentication confirms the user’s identity.

Once the attestation of the user device 102 and the cryptographic key pair is verified, the server 206 issues the token 310 against the selected resource at step 1312. The token 310 is generated by embedding the public key and the digital signature into the token 310. The token 310 binds the selected resource to the user device 102 creating the secure allocated resource 512. At step 1314, the method 1300 involves transmitting the notification to the user device 102, and updating the database 112 with the transaction details by storing the issuance record for the token. The database 112 is communicatively coupled to the server 206 and securely stores the public key associated with the token 310. The notifications function as the proof of the issuance of the token 310 on the user device 102.

At step 1316, the method 1300 involves validating the token 310 at the event location by scanning the token 310 at the scanning terminal 1220. The scanning terminal 1220 retrieves and verifies the public key and the digital signature embedded within the token 310 against the public key and the resource payload stored in the database 112. At step 1318, when the public key and the digital signature are validated, the access management system 208 grants access to the event based on the successful validation of the token 310. Otherwise, if the digital signature is not validated using the public key, access to the event is restricted.

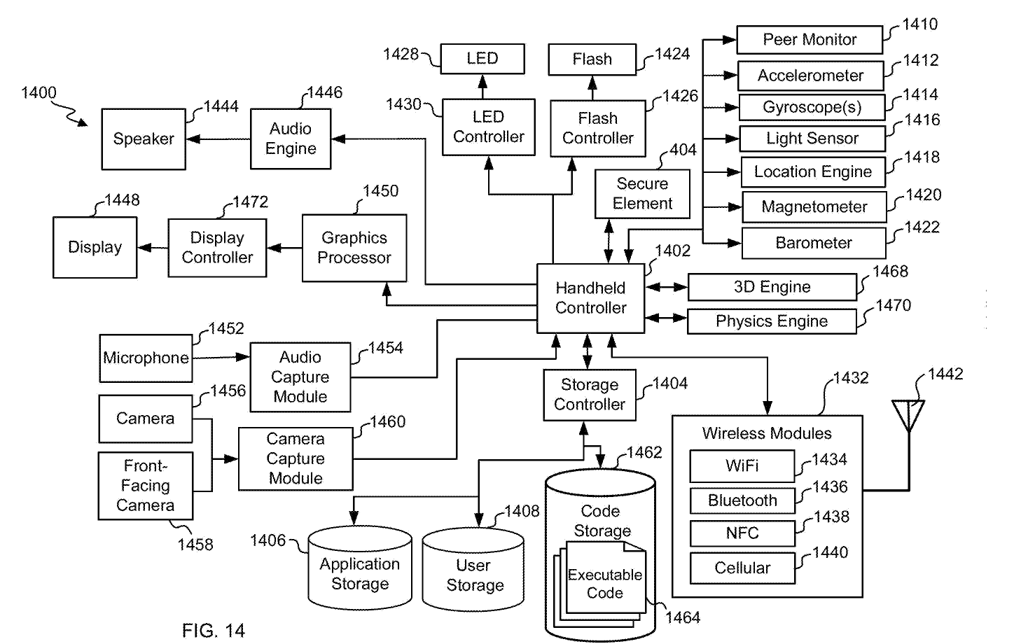

Referring next to FIG. 14, an internal system 1400 of the user device 102 is illustrated. The internal system 1400, representing the user device 102, includes a handheld controller 1402 that can be sized and shaped so as to enable holding the handheld controller 1402 and the user device 102 in a hand. The handheld controller 1402 can include one or more user devices’ processors that can be configured to perform actions as described herein.

In some instances, the actions can include retrieving and implementing a rule, retrieving an access-enabling code such as the barcode, generating a communication (e.g., including the access-enabling code) to be transmitted to another device (e.g., a nearby client-associated device, a remote device, a central server, the server 206, etc.), processing a received communication (e.g., to act in accordance with instructions in the communication, to generate a presentation based on the data in the communication, or to generate a response communication that includes the data requested in the received communication) and so on. In one embodiment, to guide the performance of different activities, the user device 102 can use executable code tangibly stored in a code storage 1462 comprising an executable code 1464.

In one exemplary embodiment, the handheld controller 1402 can communicate with a storage controller 1404 to facilitate local storage and/or retrieval of data. The handheld controller 1402 can further facilitate storage and/or retrieval of the data at a remote source via generation of communications including the data (e.g., with a storage instruction) and/or requesting particular data.

The storage controller 1404 can be configured to write and/or read data from one or more data stores, such as an application storage 1406 and/or a user storage 1408. One or more data stores can include, for example, a random-access memory (RAM), dynamic random-access memory (DRAM), read-only memory (ROM), flash-ROM, cache, storage chip, and/or removable memory. The application storage 1406 can include various types of application data for an individual application loaded (e.g., downloaded, or pre-installed) onto the user device. For example, the individual application can include applications configured for scanning the secure allocated resource 512 at the entrance of the event location, applications running non-custodial wallets, and applications for other transactions at the event location. Further, the application data can include, for example, application code, settings, profile data, databases, session data, history, cookies, and/or cache data. The user storage 1408 can include, for example, files, documents, images, videos, voice recordings, and/or audio. The user device 102 can also include other types of storage and/or stored data, such as code, files, and data for an operating system configured for execution on the user device 102.

In one exemplary embodiment, the handheld controller 1402 can also receive and process (e.g., in accordance with code or instructions generated in correspondence to a particular application) data from one or more sensors and/or detection engines. One or more sensors and/or detection engines can be configured to, for example, detect the presence, intensity, and/or the identity of (for example) another device (e.g., a nearby device or device-detectable over a particular type of networks, such as a Bluetooth, Bluetooth Low-Energy or the NFC network); an environmental, external stimulus (e.g., temperature, water, light, motion or humidity); an internal stimulus (e.g., temperature); a device performance (e.g., processor or memory usage); and/or a network connection (e.g., to indicate whether a particular type of connection is available, network strength and/or network reliability). The sensors and detection engines include a peer monitor 1410, an accelerometer 1412, a gyroscope 1414, a light sensor 1416, a location engine 1418, a magnetometer 1420, and a barometer 1422. An individual sensor and/or detection engine can be configured to collect a measurement or decide, for example, at routine intervals or times and/or upon receiving a corresponding request (e.g., from a processor executing an application code).

The peer monitor 1410 can monitor communications, networks, radio signals, short-range signals, etc., which can be received by a receiver of the user device 102. The peer monitor 1410 can, for example, detects the short-range communication from another device and/or uses a network multicast or broadcast to request identification of nearby devices. Upon or while detecting another device, the peer monitor 1410 can determine an identifier, a device type, an associated user, network capabilities, the operating system, and/or authorization associated with the user device 102. The peer monitor 1410 can maintain and update a data structure to store a location, identifier, and/or characteristic of nearby user devices.

The accelerometer 1412 can be configured to detect the proper acceleration of the user device 102. The acceleration can include multiple components associated with various axes and/or a total acceleration. The gyroscope 1414 can be configured to detect one or more orientations (e.g., via detection of angular velocity) of user device 102. The gyroscope 1414 can include, for example, one or more spinning wheels or discs, single- or multi-axis (e.g., three-axis) micro-electromechanical system (MEMS) based gyroscopes.

The light sensor 1416 can include, for example, a photosensor, such as a photodiode, an active-pixel sensor, a light emitting diode (LED), a photoresistor, or other component configured to detect a presence, intensity, and/or type of light. In some instances, one or more sensors and detection engines can include a motion detector, which can be configured to detect motion. Such motion detection can include processing data from one or more light sensors (e.g., performing a temporal and/or differential analysis).

The location engine 1418 can be configured to detect (e.g., estimate) the location of the user device 102. For example, the location engine 1418 can be configured to process signals (e.g., a wireless signal, a global positioning system (GPS) satellite signal, cell-tower signal, iBeacon, or base-station signal) received at one or more receivers (e.g., a wireless-signal receiver and/or GPS receiver) from a source (e.g., a GPS satellite, cellular tower or base station, or WiFi access point) at a defined or identifiable location. In some instances, the location engine 1418 can process signals from multiple sources and can estimate the location of the user device 102 using a triangulation technique. In some instances, the location engine 1418 can process a single signal and estimate its location as being the same as the location of the source of the signal.

The user device 102 can include a flash 1424 and a flash controller 1426. The flash 1424 can include a light source, such as (for example), the LED, electronic flash, or high-speed flash. The flash controller 1426 can be configured to control when the flash 1424 emits light. In some instances, the determination includes identifying an ambient light level (e.g., via data received from the light sensor 1416) and determining that the flash 1424 is to emit light in response to a picture- or movie-initiating input when the light level is below a defined threshold (e.g. when a setting is in an auto-flash mode). In some additional or alternative instances, the determination includes determining that the flash controller 1426 is, or is not, to emit light in accordance with a flash on/offsetting. When it is determined that the flash controller 1426 is to emit light, the flash controller 1426 can be configured to control the timing of the light to coincide, for example, with a time (or right before) at which a picture or video is taken.

The user device 102 can also include an LED 1428 and an LED controller 1430. The LED controller 1430 can be configured to control when the LED 1428 emits light. The light emission can be indicative of an event, such as whether a message has been received, a request has been processed, an initial access time has passed, etc.

The flash controller 1426 can control whether the flash controller 1426 emits light by controlling a circuit to complete a circuit between a power source and the flash controller 1426 when the flash 1424 is to emit light. In some instances, the flash controller 1426 is wired to a shutter mechanism to synchronize light emission and collection of image or video data.

The user device 102 can be configured to transmit and/or receive signals from other devices or systems (e.g., over one or more networks, such as network(s)). These signals can include wireless signals, and accordingly, the user device 102 can include one or more wireless modules 1432 configured to appropriately facilitate the transmission or reception of wireless signals of a particular type. The wireless modules 1432 can include a Wi-Fi 1434, a Bluetooth 1436, an NFC 1438, and/or a cellular 1440 module. An individual module can, for example, generate a signal (e.g., which can include transforming a signal generated by another component of the user device 102 to conform to a particular protocol and/or to process a signal (e.g., which can include transforming a signal received from another device to conform with a protocol used by another component of user device 102).

The Wi-Fi 1434 can be configured to generate and/or process radio signals with a frequency such as between 2.4 gigahertz and 5 gigahertz. The Wi-Fi 1434 can include a wireless network interface card that includes circuitry to facilitate communication using a particular basic (e.g., physical, and/or link-layer basic). The Bluetooth 1436 can be configured to generate and/or process radio signals with a frequency between 2.4 gigahertz and 2.485 gigahertz. In some instances, the Bluetooth 1436 can be configured to generate and/or process Bluetooth low-energy (BLE or BTLE) signals with a frequency between 2.4 gigahertz and 2.485 gigahertz. The NFC 1438 can be configured to generate and/or process radio signals with a frequency of 13.56 megahertz. The NFC 1438 can include an inductor and/or can interact with one or more loop antennas. The cellular 1440 module can be configured to generate and/or process cellular signals at ultra-high frequencies (e.g., between 698 and 2690 megahertz). For example, the cellular 1440 module can be configured to generate uplink signals and/or to process received downlink signals.

The signals generated by the wireless modules 1432 can be transmitted to one or more other devices (or broadcast) by antennas 1442. The signals processed by the wireless modules 1432 can include those received by the antennas 1442. The antennas 1442 can include, for example, a monopole antenna, helical antenna, antenna, Planar Inverted-F Antenna (PIFA), modified PIFA, and/or one or more loop antennae.

The user device 102 can include various input and output components. An output component can be configured to present output. For example, a speaker 1444 can be configured to present an audio output by converting an electrical signal into an audio signal. An audio engine 1446 can affect particular audio characteristics, such as volume, event-to-audio-signal mapping, and/or whether the audio signal is to be avoided due to a silencing mode (e.g., a vibrate or do-not-disturb mode set at the device).

Further, a display 1448 is provided with a display controller 1472 and can be configured to present a visual output by converting an electrical signal into a light signal. The display 1448 can include multiple pixels, each of which can be individually controllable, such that the intensity and/or color of each pixel can be independently controlled. The display 1448 can include, for example, an LED- or a liquid crystal display (LCD).

A graphics processor 1450 can determine a mapping of electronic image data to pixel variables on a screen of the user device 102. It can further adjust lighting, texture, and color characteristics in accordance with, for example, user settings.

In some instances, the display 1448 is a touchscreen display (e.g., a resistive or capacitive touchscreen) and is thus both an input and an output component. The graphics processor 1450 can be configured to detect whether, where and/or how (e.g., a force of) a user touched the display 1448. The determination can be made based on an analysis of capacitive or resistive data.

An input component can be configured to receive input from a user that can be translated into data. For example, the user device 102 can include a microphone 1452 that can capture audio data and transform the audio signals into electrical signals. An audio capture module 1454 can determine, for example, when an audio signal is to be collected and/or any filter, equalization, noise gate, compression, and/or clipper that is to be applied to the signal.

The internal system 1400 illustrates that the user device 102 can further include a camera 1456, and a front-facing camera 1458, an individual of which can be configured to capture visual data (e.g., at a given time or across an extended period) and convert the visual data into electrical data (e.g., electronic image or video data). In some instances, the user device 102 includes multiple cameras, at least two of which are directed in different and/or opposite directions. For example, the user device 102 can include the camera 1456 that is a rear-facing camera and the front-facing camera 1458.

A camera capture module 1460 can control, for example, when a visual stimulus is to be collected (e.g., by controlling a shutter), a duration for which a visual stimulus is to be collected (e.g., a time that a shutter is to remain open for a picture taking, which can depend on a setting or ambient light levels; and/or a time that a shutter is to remain open for a video taking, which can depend on inputs), a zoom, a focus setting, and so on. When the user device 102 includes multiple cameras, the camera capture module 1460 can further determine which camera(s) is to collect image data (e.g., based on a setting). In some embodiments, components are included that assist with the processing and utilization of sensor data. A 3D engine 1468, and a physics engine 1470 can fully process sensor data and also perform tasks of graphics rendering related to the graphics processor 1450.

The internal system 1400 illustrates that the user device 102 further integrates the secure element 404, communicatively coupled with the handheld controller 1402, an integral component designed for securely generating and managing the cryptographic key pairs. The secure element 404 is the hardware-protected module within the user device 102, that is tamper-resistant and provides isolated execution of crucial security operations. Further, the secure element 404 is configured to enable the generation of the cryptographic key pair. The secure element 404 comprises the private key 1108 securely stored on the user device 102 and the public key to be embedded in the resource payload.

In particular, the secure element 404 is configured to digitally sign the generated public key with the certificate of conformance, providing the attestation of the cryptographic key pair indicating authenticity and trustworthiness of the cryptographic key pair and the user device 102. In other words, this attestation can be verified by the server 206, which cross-references the certificate of conformance against the certificates stored in the pre-approved certificate authority repository. This process enables the cryptographic operations are performed within a trusted environment, forming the basis for binding the event resources to the user device 102 securely.

Furthermore, the secure element 404 interfaces with the handheld controller 1402 to integrate cryptographic functionality into the overall operation of the user device 102. For example, when the selected resource is requested, the secure element 404 generates the cryptographic key pair and provides the attested public key to the server 206. Upon verification, the public key is embedded into the secure allocated resource 512, which is then transmitted to the user device 102. This enables that the secure allocated resource 512 is cryptographically bound to the specific user device, preventing unauthorized duplication or use.

In one exemplary embodiment, the inclusion of the secure element 404 within the user device 102 enables hardware-based cryptographic functions that enhance the resource security and usability. For example, at the event location, the secure element 404 facilitates the generation of the digital signature using the private key 1108. This digital signature is validated by the scanning terminal 1220 to confirm the authenticity of the token 310. This process not only secures the resource validation but also ensures compliance with industry-basic cryptographic protocols.

In another exemplary embodiment of the present disclosure, the secure element 404 provides a high level of security by isolating cryptographic operations within a tamper-resistant environment. This isolation reduces the risk of unauthorized access to the private key 1108 or the manipulation of cryptographic processes. Additionally, the use of the certificate of conformance ensures that only devices equipped with trusted secure elements can participate in the resource allocation process, significantly enhancing the system’s overall trust model.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term "storage medium" may represent one or more memories for storing data, including read only memory (ROM), random access memory (RAM), magnetic RAM, core memory, magnetic disk storage mediums, optical storage mediums, flash memory devices and/or other machine readable mediums for storing information. The term "machine-readable medium" includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, Erasable Programmable ROMs (EPROMs), Electrically EPROMs (EEPROMs), magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

We claim:

1. A method for securely managing event resources, the method comprising:
receiving, by a server, a request for a resource associated with an event from a user device, wherein the user device is connected to the server via an Application Programming Interface (API) gateway;
generating, by the server, a list of available resources of the event, wherein the list is dynamically generated based on real-time availability data;
receiving, by the server, a request for a selected resource from the list of the available resources;
generating, by a secure element on the user device, a cryptographic key pair, wherein the secure element is a hardware-protected module in the user device,
wherein the cryptographic key pair comprises a private key and a public key, and the secure element creates a digital signature by signing the public key using a certificate of conformance to attest to trustworthiness of the cryptographic key pair;
verifying, by the server, an attestation of the cryptographic key pair by validating the certificate of conformance and validating that the certificate of conformance is listed in a pre-approved certificate authority repository, wherein the verification confirms that the cryptographic key pair originates from a secure and authorized user device;
issuing, by the server, a token associated with the selected resource, wherein the token is generated by embedding the public key and the digital signature into the token, thereby binding the selected resource to the user device;
transmitting, by the server, a notification to the user device confirming an issuance of the token, and updating a database with transaction details by storing an issuance record for the token, wherein the database is communicatively coupled to the server and securely stores the public key associated with the token;
validating, at an event location, the token by scanning the token at a scanning terminal, wherein the scanning terminal is operable to retrieve and verify the public key embedded within the token against the public key stored in the database; and
granting access to the event based on a successful validation of the token, wherein the access is granted based on a determination that the public key embedded within the token matches the public key stored in the database.

2. The method for securely managing event resources of claim 1, wherein the secure element creates the digital signature by using the private key, wherein the digital signature includes metadata identifying an origin of the secure element, and wherein the scanning terminal validates the digital signature embedded within the token to confirm authenticity of the token.

3. The method for securely managing event resources of claim 1, further comprises refreshing the digital signature generated by the secure element on the user device at predefined intervals, wherein the digital signature is generated by the secure element prior to validation of the token at the scanning terminal.

4. The method for securely managing event resources of claim 1, wherein the private key is stored in the secure element, and the cryptographic key pair enables the private key to remain confidential and resistant to tampering.

5. The method for securely managing event resources of claim 1, wherein the notification transmitted to the user device includes a digitally signed confirmation, functioning as a proof of the issuance of the token and secure binding to the user device.

6. The method for securely managing event resources of claim 1, wherein the database is configured to store an immutable record of transactions, indicating that the issuance of the token and associated data are unalterable post-issuance.

7. The method for securely managing event resources of claim 1, wherein the scanning terminal at the event location is configured to perform an offline validation of the token by retrieving and verifying the public key and the digital signature embedded in the token against locally stored verification data.

8. The method for securely managing event resources of claim 1, wherein the server is operable to:
issue a new token upon receiving a resource transfer request, wherein the new token is generated with one or more of a new cryptographic key pair and reusing the cryptographic key pair, securely binding the token to a different user device; and
generate a temporary token and send the temporary token to a wallet of the user device, when the certificate of conformance is invalid.

9. The method for securely managing event resources of claim 1, wherein the token is periodically refreshed by updating the digital signature based on the private key, wherein the digital signature is updated to provide security to the token by preventing the token from duplication or unauthorized reuse.

10. The method for securely managing event resources of claim 1, wherein the server includes an access management module that dynamically adjusts access rights based on real-time event conditions, comprising one or more of a change in resource availability, user authentication, and security alerts.

11. The method for securely managing event resources of claim 1, wherein the scanning terminal is further configured to generate a real-time access log, record a success or failure of token validation attempts, and transmit the real-time access log to the server for audit and security purposes.

12. The method for securely managing event resources of claim 1, wherein the server assesses a usage of an attested cryptographic key pair to detect an irrational pattern exhibited by the user device, wherein the server invalidates the attested cryptographic key pair and/or restricts the user device from getting the token upon detection of the irrational pattern.

13. A system for securely managing event resources, the system comprising:
a user device configured to request a resource associated with an event and connect to a server via an Application Programming Interface (API) gateway, wherein the user device comprises:
a secure element configured to generate a cryptographic key pair, wherein the secure element is a hardware-protected module in the user device, wherein the cryptographic key pair comprises a private key and a public key, and the secure element creates a digital signature by signing the public key using a certificate of conformance to attest to trustworthiness of the cryptographic key pair;
the server configured to:
receive a request for the resource from the user device,
generate a list of available resources of the event, wherein the list is dynamically generated based on real-time availability data,
receive a request for a selected resource from the list of the available resources,
verify an attestation of the cryptographic key pair by validating the certificate of conformance and validating that the certificate of conformance is listed in a pre-approved certificate authority repository, wherein the verification confirms that the cryptographic key pair originates from a secure and authorized user device,
issue a token associated with the selected resource, wherein the token is generated by embedding the public key and the digital signature into the token, thereby binding the selected resource to the user device, and
transmit a notification to the user device confirming an issuance of the token, and update a database with transaction details by storing an issuance record for the token, wherein the database is communicatively coupled to the server and securely stores the public key associated with the token; and
a scanning terminal at an event location, the scanning terminal configured to:
retrieve and verify the public key embedded within the token against the public key stored in the database to validate the token, and
grant access to the event based on a successful validation of the token, wherein the access is granted based on a determination that the public key embedded within the token matches the public key stored in the database.

14. The system for securely managing event resources of claim 13, wherein the secure element creates the digital signature by using the private key, wherein the digital signature includes metadata identifying an origin of the secure element, and wherein the scanning terminal validates the digital signature embedded within the token to confirm authenticity of the token.

15. The system for securely managing event resources of claim 13, wherein the private key is stored in the secure element, and the cryptographic key pair enables the private key to remain confidential and resistant to tampering.

16. The system for securely managing event resources of claim 13, wherein the notification transmitted to the user device includes a digitally signed confirmation, functioning as a proof of the issuance of the token and secure binding to the user device.

17. The system for securely managing event resources of claim 13, wherein the scanning terminal at the event location is configured to perform an offline validation of the token by retrieving and verifying the public key and the digital signature embedded in the token against locally stored verification data.

18. The system for securely managing event resources of claim 13, wherein the server is further configured to:
issue a new token upon receiving a resource transfer request, wherein the new token is generated with one or more of a new cryptographic key pair and reusing the cryptographic key pair, securely binding the token to a different user device; and
generate a temporary token and send the temporary token to a wallet of the user device, when the certificate of conformance is invalid.

19. The system for securely managing event resources of claim 13, wherein the server includes an access management module that dynamically adjusts access rights based on real-time event conditions, comprising one or more of a change in resource availability, user authentication, and security alerts.

20. The system for securely managing event resources of claim 13, wherein the server assesses a usage of an attested cryptographic key pair to detect an irrational pattern exhibited by the user device, wherein the server invalidates the attested cryptographic key pair and/or restricts the user device from getting the token upon detection of the irrational pattern.
